(19) United States
(12) Patent Application Publication
(10) Pub. No.: US 2011/0169474 A1
(43) Pub. Date: Jul. 14, 2011

(54) Step-down switching PFC converter

(75) Inventor: Slobodan Cuk, Laguna Niguel, CA (US)

(73) Assignee: CUKS, LLC

(21) Appl. No.: 12/930,448

(22) Filed: Jan. 7, 2011

Related U.S. Application Data
(60) Provisional application No. 61/335,557, filed on Jan. 9, 2010.

(51) Int. Cl. G05F 3/08

(52) U.S. Cl. 323/311

(57) ABSTRACT

The step-down switching converter is provided, which promises to replace the conventional buck converter in many applications due to its many advantage, such as higher efficiency, smaller size, fast transient response and lower cost among other benefits.

### CROSS-REFERENCE TO RELATED APPLICATIONS

### Provisional U.S. Patent Application No. 61/335,557

### Filed on Jan. 9, 2010

### Applicant: Slobodan Cuk

### Title: Step-down Switching PFC Converter

### Confirmation Number: 2911

### FIELD OF INVENTION

The general field of invention is switching DC-DC converters with large step-down DC voltage characteristics. More specifically it also belongs to the class of non-isolated DC-DC converters. The present non-isolated switching DC-DC converters used for large power conversion (100 W or more) and large currents (10 A to 100 A and more) exclusively use the classical (conventional) buck converter which consists of switches and inductor as a main energy transferring device between input DC source and output DC load while the capacitor is used on the converter output only to reduce switching voltage ripple on the output, but it is not participating in the input to output energy transfer. The present computers demand a low voltage source of 0.5V to 1.5V and require very large currents of 100 A or more with an ultra fast steep step-load current change of 30 A/per microseconds or more. Yet, the primary source of DC power available is 12V source, which imposes a requirement for DC-DC converter to provide a large DC voltage step-down of 12:1 and at the same time a fast load current transient.

The present solutions are all based on the use of various multiphase buck converter with separate or coupled inductors in which at least four or more (often six or eight) buck converters are operated at a very high switching frequency (such as 800 kHz) but phase shifted from each other so that the effective output ripple current is at four times higher switching frequency, so that the ripple voltage on output could be reduced sufficiently. Hence an effective switching frequency is 3.2 MHz or 6.4 MHz. Despite such high effective switching frequency and use of coupled-inductor magnetics, the rather large coupled-inductor structures with relatively large magnetic cores still needs to be employed.

Use of conventional switched-capacitor converters, which consists of switches and capacitors only and no inductors, can achieve the large voltage step-down voltage conversion ratio. The larger number of switches and the larger number of capacitors employed a higher voltage conversion step-down ratio can be obtained. However, the switched capacitor DC-DC converters are limited to very low power (typically bellow 1 W) and low current levels (typically bellow 1 A) due to their inherent inefficiency originating in abrupt charge transfer from one capacitor to another. However, by elimination of the bulky inductors requiring magnetic cores, they led naturally to the integration of all switching components into small size Integrated circuit (IC) with external use of small ceramic chip capacitors.

The present invention belongs to a new class of switching DC-DC converters which consists of a large number of switches and capacitors and only a single small size air-core inductor (magnetic core eliminated for most applications) which is suitable for low voltage 1V), high power (100 W or more) and high current (100 A) or more) and capable of large 12:1 or higher step-down conversion ratios, fast load current transient (30 A/microseconds) and continuous output DC voltage control over the wide range of the output DC voltage and load current change. The elimination of the bulky inductors requiring magnetic cores, leads naturally to the integration of all switching components into small size Integrated circuit (IC) with external use of small ceramic chip capacitors and a single air-core inductor. All switches operate at zero current and zero voltage at both turn-ON and turn-OFF thus eliminating switching losses and resulting in high conversion efficiencies limited only by device conduction losses and gate drive losses. As the switching frequencies employed are moderate at 100 kHz the gate drive loses are also low.

The present multi-phase buck converters despite operation at ultra high switching frequency still stores the energy in its inductors and limits the transient response of the converter. The present invention opens up a new category of DC-DC converters which do not store DC energy in magnetics and therefore result in much improved transient response even at moderate switching frequencies of 100 kHz or less, while simultaneously providing ultra high efficiency, compact size and low weight due to integration of switching devices into one IC circuit and use of external small chip capacitors and single air-core inductor.

### DEFINITIONS AND CLASSIFICATIONS

The following notation is consistently used throughout this text in order to facilitate easier delineation between various quantities:
1. DC—Shorthand notation historically referring to Direct Current but by now has acquired wider meaning and refers generically to circuits with DC quantities;
2. AC—Shorthand notation historically referring to Alternating Current but by now has acquired wider meaning and refers to all Alternating electrical quantities (current and voltage);
3. i₁, v₂—The instantaneous time domain quantities are marked with lower case letters, such as i₁ and v₂ for current and voltage;
4. I₁, V₂—The DC components of the instantaneous periodic time domain quantities are designated with corresponding capital letters, such as I₁ and V₂;
5. ΔV—The AC ripple voltage on resonant capacitor Cᵣ;
6. f_{S}—Switching frequency of converter;
7. T_{S}—Switching period of converter inversely proportional to switching frequency f_{S};
8. T_{ON}—ON-time interval T_{ON}=DT_{S} during which switches S₁ are turned-ON;
9. T_{OFF}—OFF-time interval T_{OFF}=D′T_{S} during which complementary switches S₂ are turned-OFF;
10. D—Duty ratio of the controllable switches S₁;
11. S₂—controllable switches, which operates in complementary way to switch S₁: when S₁ is closed S₂ is open and opposite, when S₁ is open S₂ is closed;
12. D′—Complementary duty ratio D′=1-D of the switch S₂ complementary to main controlling switch S₁;
13. fᵣ₁—first resonant frequency defined by resonant inductor Lᵣ and resonant capacitors connected in series during the ON-time interval;
14. fᵣ₂—second resonant frequency defined by resonant inductor Lᵣ and resonant capacitors connected in parallel during the OFF-time interval;
15. Tᵣ₁—first resonant period defined as Tᵣ₁=1/fᵣ₁;
16. Tᵣ₂—second resonant period defined as Tᵣ₂=1/fᵣ₂;
17. tᵣ₁—One half of resonant period Tᵣ₁;
18. tᵣ₂—One half of resonant period Tᵣ₂;
19. S₁—Controllable switch with two switch states: ON and OFF;
20. CR₁—Two-terminal Current Rectifier whose ON and OFF states depend on controlling S₁ switch states and first resonant circuit conditions.
21. CR₂—Two-terminal Current Rectifier whose ON and OFF states depend on controlling S₂ switch states and second resonant circuit conditions.

The quadrant definition of the switches is given in FIG. 1c-g.

### BRIEF DESCRIPTION OF THE DRAWINGS

FIG. 1a illustrates a prior-art buck converter and FIG. 1b illustrates the state of the switches for the buck converter of FIG. 1a. FIG. 1c shows ideal four-quadrant mechanical switch which can conduct current of either direction and block the voltage of either polarity, FIG. 1d shows one-quadrant switch implemented by a two-terminal passive device current rectifier CR (diode) operating in second quadrant, FIG. 1e shows a bipolar active three-terminal electronic switch implanted as a NPN bipolar transistor operating in the first quadrant, FIG. 1f shows a two-quadrant Current Bi-directional switch operated in first and fourth quadrant implemented with a single MOSFET switch and internal body diode, and FIG. 1g shows a two-quadrant Voltage Bi-directional switch (VBS) operating in first and second quadrant and implemented as a composite switch, consisting of a series connection of a transistor (bipolar or MOSFET) and the current rectifier (diode).

FIG. 2a illustrates inductor current of the buck converter in FIG. 1a, and FIG. 2b illustrates inductor current transient from 25% load to 100% load current for the buck converter of FIG. 1a.

FIG. 3a shows a magnetic core with the air-gap needed for inductor of buck converter in FIG. 1a, and FIG. 3b shows the inductor current with DC-bias and corresponding flux linkages. FIG. 3c illustrates the volt-second requirements for the inductor of the buck converter in FIG. 1a and FIG. 3d shows the volt-seconds as a function of the duty ratio D.

FIG. 4a shows a four-phase buck converter. FIG. 4b illustrates one coupled-inductor implementation of the two-phase buck converter, and FIG. 4c illustrate the two-phase coupled-inductor buck converter.

FIG. 5a illustrates one embodiment of the present invention, which consists of a single resonant inductor and a number of resonant capacitors and switches, and FIG. 5b illustrates the state of the switches in the converter of FIG. 5a. This figure also defines the four-terminal block and uses the component designations consistent with the names used in the claims. FIG. 5c shows the linear circuit obtained for the ON-time interval and FIG. 5d shows an equivalent circuit for the circuit in FIG. 5c with series combination of capacitors replaced by an equivalent resonant capacitor Cᵣ₁ and FIG. 5e shows simplified equivalent circuit when output capacitor C is large compared to equivalent resonant capacitor Cᵣ₁. FIG. 5f shows the linear circuit obtained for the OFF-time interval for the converter of FIG. 5a and FIG. 5g shows an equivalent circuit for the circuit in FIG. 5a with parallel combination of capacitors replaced by an equivalent resonant capacitor Cᵣ₂ and FIG. 5h shows simplified equivalent circuit when output capacitor C is large compared to equivalent resonant capacitor Cᵣ₂. FIG. 5i shows the salient waveform of the resonant inductor current when the converter of FIG. 5a is operated with constant OFF-time interval and variable ON-time interval, which is shorter than half of the first resonant period to result in continuous output DC voltage reduction bellow ⅓.

FIG. 6a shows the generalized converter with N stages with all switches being ideal switches capable to conduct the current in either direction. Note the absence of unidirectional output current rectifiers CR₁ and CR₂. FIG. 6b shows an experimental waveform obtained on a prototype of a converter in FIG. 6a converter, which demonstrates that resonant current could flow in either direction (charging and discharging) unless proper measures are taken that charging of capacitors in series takes place only during ON-time interval, and their discharging only during OFF-time interval

FIG. 7a shows that in this converter implementation using output current rectifiers CR₁ and CR₂, the duty ratio D and switching frequency could be chosen so that the desirable waveform of resonant inductor current is obtained so that charging takes place only during ON-time interval and discharging only during the OFF-time interval as seen in resonant current waveform of FIG. 7b. FIG. 7c shows the switch-states of the controllable switches for the constant switching frequency operation and FIG. 7d shows the corresponding resonant inductor current waveform with zero current coasting intervals.

FIG. 8a shows the linear circuit obtained for the ON-time interval and FIG. 8b shows an equivalent circuit for the circuit in FIG. 5a with series combination of capacitors replaced by an equivalent resonant capacitor Cᵣ₁ and FIG. 8c shows simplified equivalent circuit when output capacitor C is large compared to equivalent resonant capacitor Cᵣ₁.

FIG. 9a shows the linear circuit obtained for the OFF-time interval for the converter of FIG. 6a and FIG. 9b shows an equivalent circuit for the circuit in FIG. 5a with parallel combination of capacitors replaced by an equivalent resonant capacitor Cᵣ₂ and FIG. 5h shows simplified equivalent circuit when output capacitor C is large compared to equivalent resonant capacitor Cᵣ₂.

FIG. 10a shows that unequal capacitor values could introduce the circulating currents and FIG. 10b shows that the circulation currents are minimized when equal capacitor values are chosen.

FIG. 11a shows the converter of FIG. 9a when S₁ switches are closed, FIG. 11b shows equivalent circuit for FIG. 11a, and FIG. 11c shows the waveform of the resonant inductor current iₜ during the ON-time interval.

FIG. 12a shows the converter of FIG. 9a when S₂ switches are closed, FIG. 12b shows equivalent circuit for FIG. 12a, and FIG. 12c is the waveform of the resonant inductor current iₜ during the OFF-time interval.

FIG. 13a shows the salient features of the current waveforms for the capacitors C₁, C₂, Cₙ₋₁, which all must be charge balanced as illustrated by equal shaded areas and FIG. 13b shows the resonant inductor current waveform illustrating that this current during OFF-time interval is equal to the sum of all resonant capacitors currents.

FIG. 14a shows the input part of the converter and the output part of the converter with respective current designations, FIG. 14b shows the input current waveform and FIG. 14c shows the output current waveform.

FIG. 15a shows the designations of iₒᵤₜ for output current before the load capacitor C and I_{L} for the DC load current and FIG. 15b shows time domain waveforms for the two currents.

FIG. 16a shows the step load current change of output current iₒᵤₜ from 25% to 100% and FIG. 16b shows the corresponding step load change of the input current iᵢₙ.

FIG. 17a shows for the converter of FIG. 9a zero current turn-ON and zero current turn-OFF of switches S₁, FIG. 17b shows the zero current turn-ON and zero current turn-OFF of diode current rectifier CR₁, FIG. 17c shows the zero current turn-ON and zero current turn-OFF of the switches S₂ and FIG. 17d shows the zero current turn-ON and zero current turn-OFF of diode current rectifier CR₂.

FIG. 18a shows the minimal switch realization of the present invention with minimum number of controllable switches and the remaining switches being current rectifiers. Note that the component designations are changed to correspond to the designations used in the claims, as this drawing is used for definition of the converter component connections in the claims. Note also that the four-terminal block is also highlighted in dotted lines for the same reason to be identified as in the claims. FIG. 18b illustrates the generalized converter with repeated four-terminal blocks.

Note that voltage stresses of switches in the four-terminal blocks are equal to low output voltage V.

FIG. 18c shows practical implementation of the converter in FIG. 5a with all n-channel MOSFET switches and FIG. 18d shows another embodiment of the present invention in which all MOSFET switches except the main input switch S have the voltage rating equal to the output DC voltage.

FIG. 19a shows another embodiment of the present invention with two resonant inductors, one in each branch of the two output current rectifiers (diodes), which permits independent adjustment of the two separate resonant intervals and FIG. 19b shows another higher efficiency embodiment of the present invention with two resonant inductors.

FIG. 20a shows another embodiment of the present invention for the special case of the 4:1 voltage step-down conversion and FIG. 20b shows another embodiment of the present invention for the special case of the 4:1 voltage step-down.

FIG. 21a shows the converter of FIG. 20a when D switches are closed and conduct, FIG. 21b shows equivalent circuit for FIG. 21a, FIG. 21c shows the converter of FIG. 20a when D′ switches are closed and conduct, and FIG. 21d shows equivalent circuit for FIG. 21c.

FIG. 22a shows the filtering of the buck converter, FIG. 22b shows how the low voltage DC is extracted from large square wave voltage on buck converter input, and FIG. 22c shows the large AC voltage waveform of the buck converter.

FIG. 23a shows an effective resonant filtering of the present invention, FIG. 23b shows how the input DC voltage to the effective filter of present invention is the same as DC output voltage V, and FIG. 23c shows the very small AC voltage waveform needed to be filtered out in present invention.

FIG. 24 illustrates the equivalent circuit used to calculate the output voltage ripple from the resonant AC ripple voltage on resonant inductor Δvᵣ.

FIG. 25 shows the experimental waveforms of the resonant current iᵣ, ripple voltage on resonant capacitor Δv_{C}, and output ripple voltage Δv.

FIG. 26a shows the 4:1 step-down converter used for experimental verification and FIG. 26b shows the waveforms from top to bottom of the ripple voltage on resonant inductor, resonant inductor current and the input current respectively.

FIG. 27a shows the converter of FIG. 26a modified by shorting one diode switch and keeping open the corresponding ideal switch so that the conversion ratio is reduced to 3:1 and FIG. 27b shows the experimental waveforms for the converter of FIG. 27a adjusted to 0.33 duty ratio and with switching frequency also adjusted for zero current crossovers.

FIG. 28a shows the converter of FIG. 26a modified by shorting two diode switches and keeping open the two corresponding ideal switches so that the conversion ratio is reduced to 2:1 and FIG. 27b shows the experimental waveforms for the converter of FIG. 28a adjusted to 0.25 duty ratio and with switching frequency also adjusted for zero current crossovers.

FIG. 29a shows an electronic implementation of the converter in FIG. 26a so that any of the conversion ratios, such as 4:1, 3:1 or 2:1 could be obtained by using the appropriate switch drive waveforms and FIG. 29b shows the switch drive waveforms for 4:1 voltage step-down.

FIG. 30a shows the switch drive waveforms of the converter in FIG. 29a for 3:1 voltage step-down, and FIG. 30b shows the switch drive waveforms of the converter in FIG. 29a for 2:1 voltage step-down.

FIG. 31a shows the discrete conversion ratios of the 4:1 step-down converter of FIG. 26a and FIG. 31b shows multitude of the discrete conversion ratios, which can be achieved, in 12:1 step-down converter.

FIG. 32a shows the converter used for verification of the continuous DC voltage control by use of the variable duty ratio D and constant switching frequency) and FIG. 32b shows the state of the converter when the duty ratio is made smaller than the half of the first resonant period.

FIG. 33a shows the equivalent circuit obtained during the charging of the capacitors in series during the ON-time interval, FIG. 33b shows the new equivalent circuit corresponding to the new converter state shown in FIG. 32b, and FIG. 33c shows the equivalent circuit during the constant OFF-time interval.

FIG. 34a shows the experimental waveforms obtained from the linear resonant circuit of FIG. 32b with current i_{b} (bottom trace) flowing through the body diode of switch S′, and FIG. 34b shows the experimental waveforms of ripple voltage Δvᵣ with marked value of voltage V, resonant current iᵣ with two distinguish time intervals DT_{S} and D₀T_{S} marked on, and input current and D₀T_{S} marks the instant when resonant inductor current is reduced to zero.

FIG. 35a shows the waveform of the resonant current iᵣ in the converter shown on FIG. 32b, FIG. 35b shows the part of the resonant current of FIG. 35a during DT_{S} time interval, FIG. 35c shows the part of the resonant current of FIG. 35a when it flows through the body diode of switch S′ (D₀T_{S}-DT_{S} time interval), and FIG. 35d shows the resonant current during OFF time interval D′T_{S}.

FIG. 36a shows directions of the input, output, and resonant currents in converter operating with controlled duty ratio D, FIG. 36b shows the waveform of the input current in converter of FIG. 36a, FIG. 36c shows the waveform of the resonant current flowing through the body diode of the switch S′ of FIG. 32b, and FIG. 36d shows the waveform of the output current of converter in FIG. 36a.

FIG. 37a shows how the variable pulsating input voltage vᵢ(t) of the buck converter is filtered by the LC filter to provide the variable output DC voltage V(t), and FIG. 37b shows how the variable pulse of the input current iₜₕ(t) of the present invention converter is filtered by the small resonant LᵣC filter to provide the variable output DC current iₒᵤₜ(t) and hence the variable output DC voltage.

FIG. 38a shows the reduction of the theoretical DC voltage conversion gain as a function of duty ratio D and with n as a parameter to generate curves for various discrete step-down conversion ratios such as 2:1, 3:1, 4:1, and (n:1) respectively and FIG. 38b shows experimental measurement of the continuous output DC voltage reduction by use of duty ratio control.

FIG. 39a shows how duty ratio reduction results in a short zero-coasting interval during OFF-time interval, and FIG. 39b shows the experimental waveforms with further reduction of the duty ratio D and output DC voltage V.

FIG. 40a shows yet another method of the continuous output DC voltage reduction operating at the constant duty ratio (D=0.0.33 for the illustrated case of 3:1 step-down converter) by using the increase of the switching frequency above resonant frequency, and FIG. 40b shows the experimental measurements of the continuous output voltage control using the switching frequency increase above resonant frequency.

FIG. 41a shows the experimental waveforms obtained with constant duty ratio D=⅓ and switching frequency f_{S} increased above fᵣ, and FIG. 41b shows further increase of switching frequency.

FIG. 42a shows waveforms obtained during the fast load current transient from 2 A to 6 A and FIG. 42b shows waveforms obtained during the fast load current transient from 6 A to 2 A.

FIG. 43a shows how the step-up load current transients effects the transient of the output voltage (less than 100 mV for a 30% step load current change in a 24 W, 4V @ 6 A converter) and FIG. 43b illustrates how the step-down load current transients effect the transient of the output voltage.

FIG. 44a shows the efficiency measured on an experimental 12V to 4V, 6A converter and FIG. 44b shows the corresponding power loss measurements obtained on the same prototype.

### PRIOR ART

### Prior-art Buck Converter

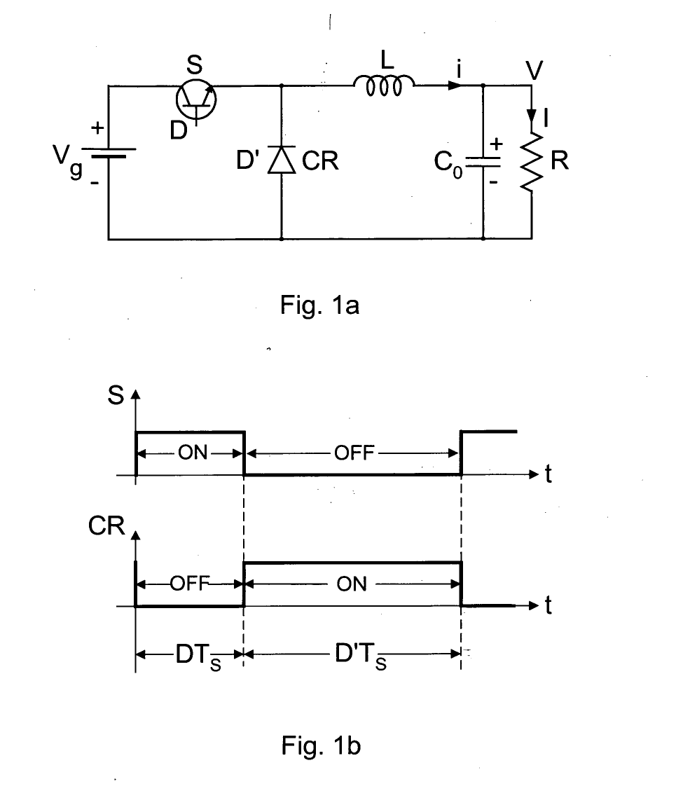

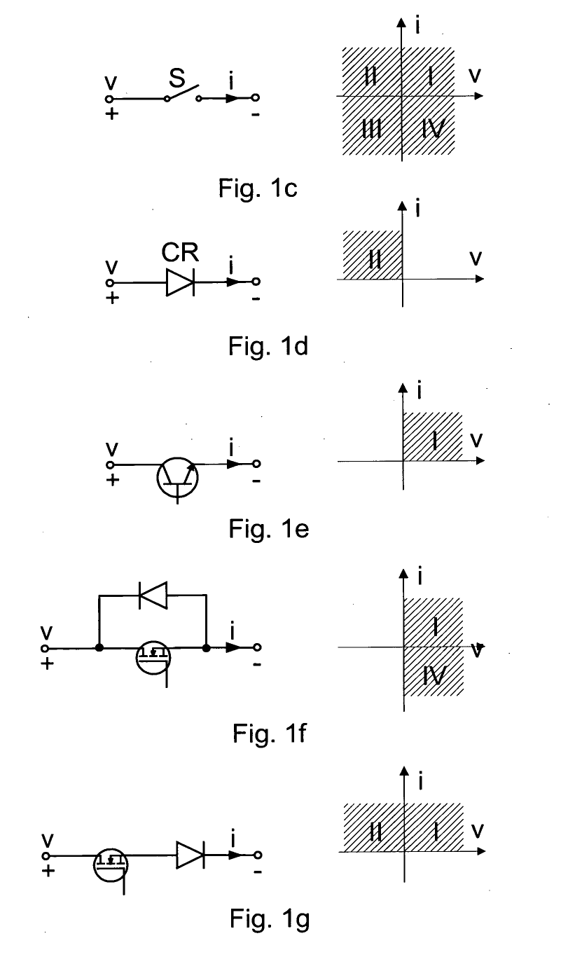

The non-isolated prior-art Pulse Width Modulated (PWM) buck switching converter shown in FIG. 1a consists of two complementary switches S and CR: when S is ON, CR is OFF i and vice versa as shown by the switch states in FIG. 1b. A Buck converter is capable only to step-down the input DC voltage and its voltage conversion is dependent in continuous conduction mode only on duty ratio D, which is defined as the ratio of the ON time of switch S, DT_{S}, and switching period T_{S}. The DC voltage conversion ratio M(D) is given by well known formula:

M(D)=V/V_{g}=D (1)

Thus, for D=½, ⅓ and ¼, the respective ideal conversion ratios M of 2:1, 3:1, and 4:1 could be achieved.

One of the current important practical applications is to power microprocessors and modern computer loads demanding one volt (1V) output voltage delivering 30 A load current from a primary DC power source of 12V, thus requiring a 12:1 voltage conversion.

### Switch Implementations

Both switches in the buck converter of FIG. 1a could be implemented by ideal four quadrant switches S defined in FIG. 1c as capable of conducting current in either direction and blocking voltage of either polarity imposed by the switching converter itself. However, the practical electronic application of the switches by use of semiconductor switching devices requires for cost and simplicity reasons the least complex implementation of the switches. Thus, the minimum switch realization of switches with minimum complexity (single-quadrant switches) of the buck converter in FIG. 1a uses a single quadrant active switch of FIG. 1e (bipolar transistor) and a single quadrant passive switch (diode rectifier CR) of FIG. 1d. For the special application requiring small size and thus operation at high switching frequency of 100 kHz or higher, a MOSFET switching transistor is used for main switch S even though this switch as shown in FIG. 1g is effectively a two quadrant current-bi-directional switch (CBS), whose function could be emulated by a parallel connection of a bipolar transistor and diode rectifier CR as also illustrated in FIG. 1g.

In low voltage applications the built-in body diode of the MOSFET switch is bypassed by the low resistance path through the transistor itself to reduce substantial conduction losses, which would be incurred by either body diode or discrete diode rectifier of FIG. 1b.

Finally, another composite switch, the two-quadrant Voltage Bi-directional Switch (VBS) is shown in FIG. 1f. Such composite switch is capable of blocking the voltage of either polarity but allows the current flow in only one direction. This latter feature will be one of the crucial characteristic of the switch implementations in the present invention and will be one of the core reasons for its many advantages as will be introduced in later section and verified in experimental prototypes.

### Inductor DC Energy Storage and Transient Response

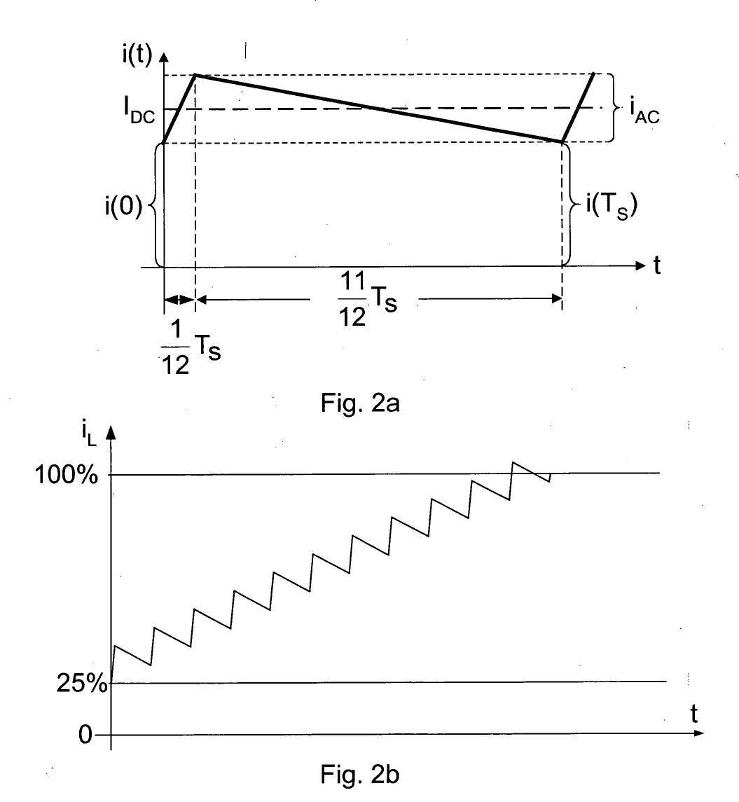

The inductor L in the buck converter of FIG. 1a, must conduct a full DC load current so that instantaneous inductor current waveform i(t) shown on FIG. 2a must have a DC-bias equal to DC load current and a superimposed AC triangular ripple current. This implies that the inductor L must store a DC energy W equal to:

W=½LI² (2)

Herein lies one of the major limitations of the prior-art buck converter and other conventional switching converters: they all must store this substantial DC energy in the inductor during every cycle. As a direct consequence, the converter cannot respond immediately to a sudden change of the load current demand, such as from 25% of the load to the full 100% load as illustrated in FIG. 2b. Instead, the buck converter must pass through a large number of switching cycles before the instantaneous inductor current settles at the new steady state level which has a full DC load current.

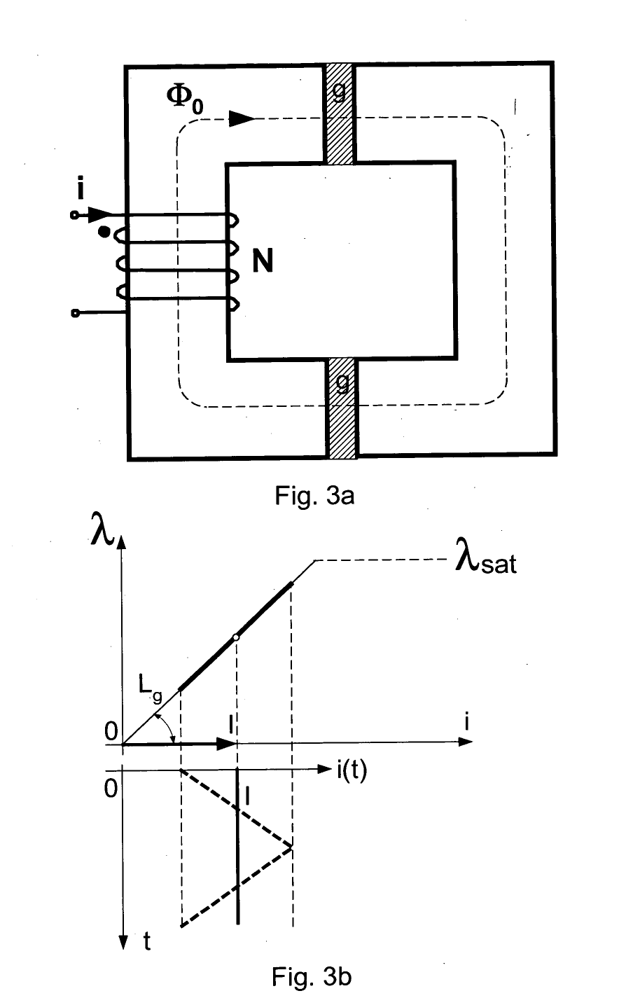

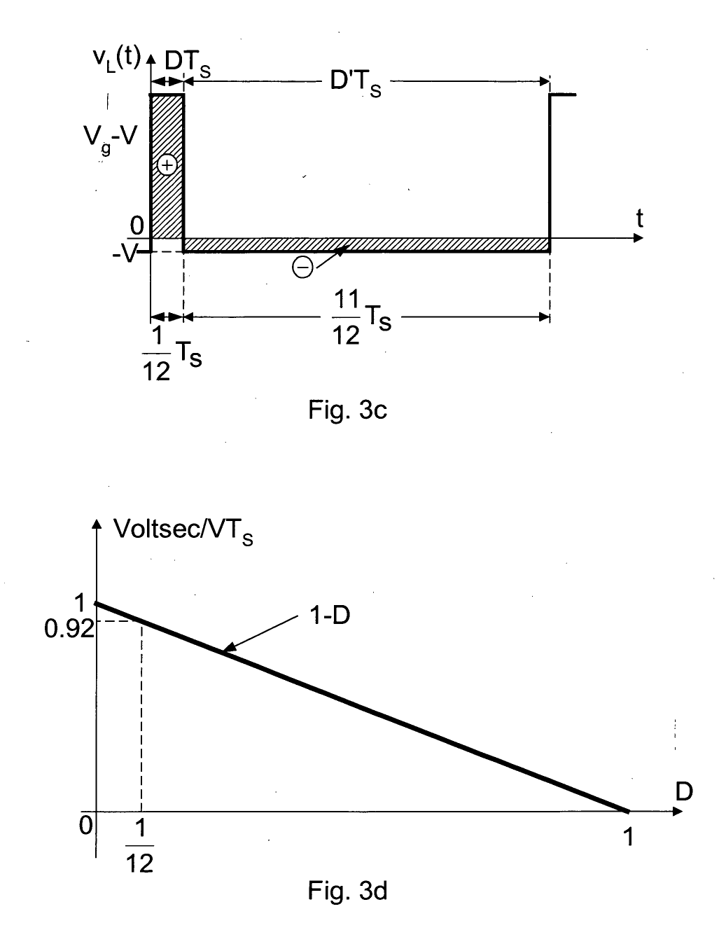

In order to store the DC energy given by (2), inductor must be built with an air-gap such as shown in FIG. 3a. The length of the air-gap is directly proportional to the DC energy, which needs to be stored. Clearly, addition of the air-gap reduces the inductance L dramatically. Therefore to obtain needed inductance one is resorted to use a larger magnetic core cross-section to make up for the loss of inductance due to the presence of the large air-gap so that an acceptable AC ripple current of around 20% peak to peak relative to DC current I is provided. Ultimately, for a very large DC currents (100 A or more), the air-gap needed is so large, that the magnetic core only increases inductance of the winding by a factor of two or three compared to an inductor winding of the same size without core material. Considering that present day ferrite materials have a relative permeability of 2,000 or more, that results in reduction of inductance by a factor of 1000.

### Large AC Flux and Magnetic Core Saturation

Size of the inductance is therefore severely affected by its need to store the DC energy (2). In addition, very large size inductor is required because it must also support a superimposed AC flux as seen in FIG. 3b and still not result in magnetic core saturation. This AC flux (Volt-seconds) of the buck converter is illustrated in FIG. 3c and shown by shaded area. The Volts-seconds imposed on the magnetic core are as calculated from:

Volt-sec/VT_{S}=1−D (3)

The graph of this dependence in FIG. 3d points out that at high step-down conversions (for example 12:1) or low operating duty ratios, the AC flux relative to VT_{S} is the highest. As output voltage V is dictated by application, the only way to reduce the core flux is to decrease switching period and therefore increase switching frequency. This is precisely how buck type and other converters handle a large core flux requirements. The present invention, however, demonstrates how the AC flux could be significantly reduced by an order of magnitude, or even more, and operate at switching frequencies 10 times lower and at the same time even eliminate the need for magnetic cores altogether.

In summary, the size of the inductor L in the prior-art buck converter is very large due to the two basic requirements:
a) need for large DC energy storage;
b) large AC volt-seconds imposed on the inductor.
   In conclusion the present approaches to minimize inductor size was to increase switching frequency indiscriminately to the high levels, such as 1 MHz and even higher which clearly negatively impacted overall efficiency. Yet, the needed inductance values are still large demanding implementation with magnetic cores despite already high switching frequency.

### Prior-art Multi-Phase Buck Converter

However, even operation at high switching frequencies of 1 MHz is not sufficient due to the need for two inherently opposing requirements:
a) Need to reduce output ripple voltage to below 1% relative ripple;
b) Need for fast transient response to large load current sudden change of 30 A/μsec or more.

The first requirement imposes the need for larger inductance values to minimize the ripple currents and ultimately output ripple voltage. Yet the fast transient response demands the opposite, the low value of the output inductance L.

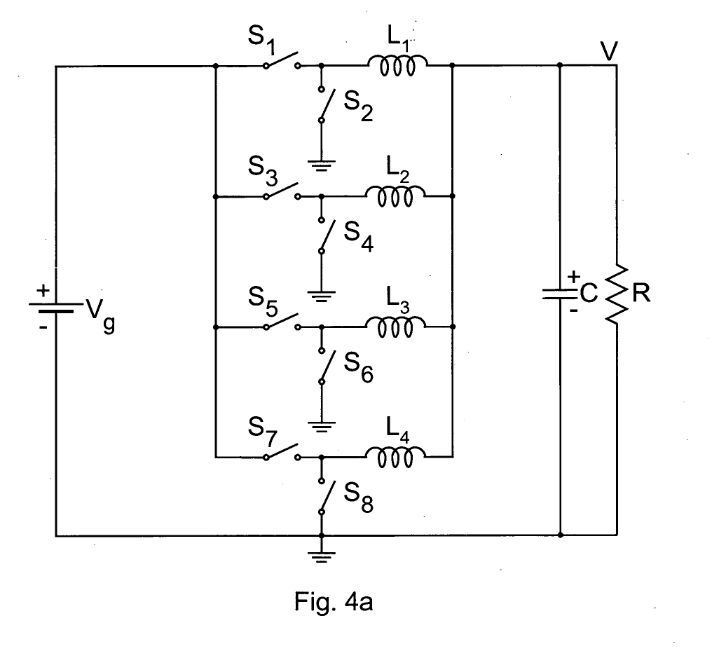

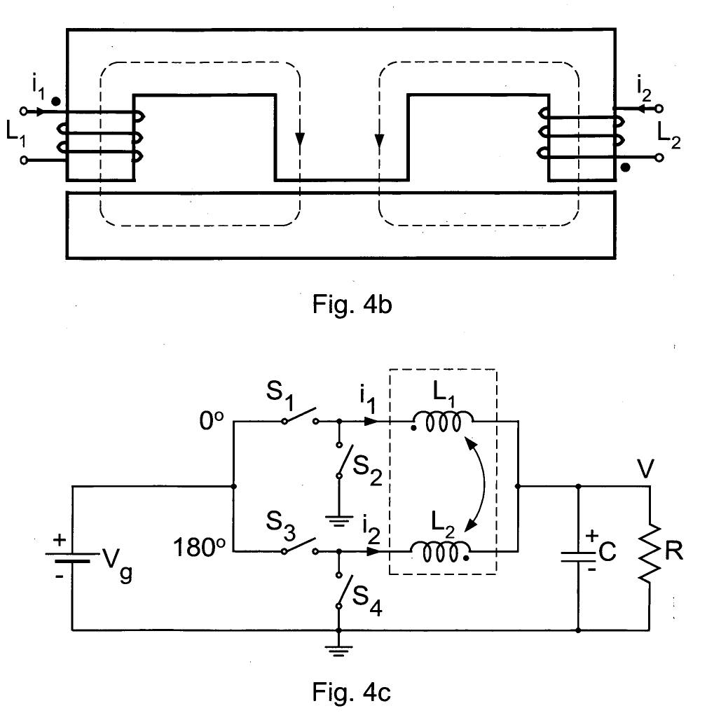

This resulted in an engineering compromise to balance the above opposing requirements on the value of the inductor L in the buck converter by use of a number of buck converters of FIG. 1a in parallel, but shifted in their phase such as shown in FIG. 4a. If each individual buck converter is operated with the same constant switching period, but active switch operation of each converter is shifted by a quarter period from the adjacent buck converter, the resulting output ripple current is at four time higher switching frequency and the combined peak to peak ripple current is also reduced in magnitude. An additional method to further reduce the size of the needed inductors is to use coupled-inductors structure. FIG. 4b illustrate the coupled inductor structure for a Two-phase phase shifted buck converter of FIG. 4c. Other coupled-inductors structures have also been proposed which provide a further reduction of the inductor value and also allow the use of chip capacitors instead of large bulk capacitors to satisfy both the fast transient response and small output ripple voltage requirements. This, however, does not eliminate the problem of stored energy but only mitigates it to some degree by providing a more optimum engineering trade-off between the two opposing requirements, albeit imposing the need for yet higher switching frequencies.

High volt-seconds (and consequent large magnetic core size requirements) and DC-bias and air-gap seem to be inevitable in switching power conversion. However, this is not the case, as the present invention of the switching converter with large step-down DC gain characteristic introduced in the next section will demonstrate.

### Objectives

The main objective is to replace the current prior-art buck converter with an alternative solution, which exceeds the performance of the buck converter by providing simultaneously higher efficiency, reduced size, weight and cost, and the fast transient response as well. The transient response is made inherently fast as the converter of the present invention will respond each cycle immediately to the current demand imposed by the load, without the need for energy storage.

### SUMMARY OF THE INVENTION

### Basic Operation of Step-Down Switching DC-DC Converter

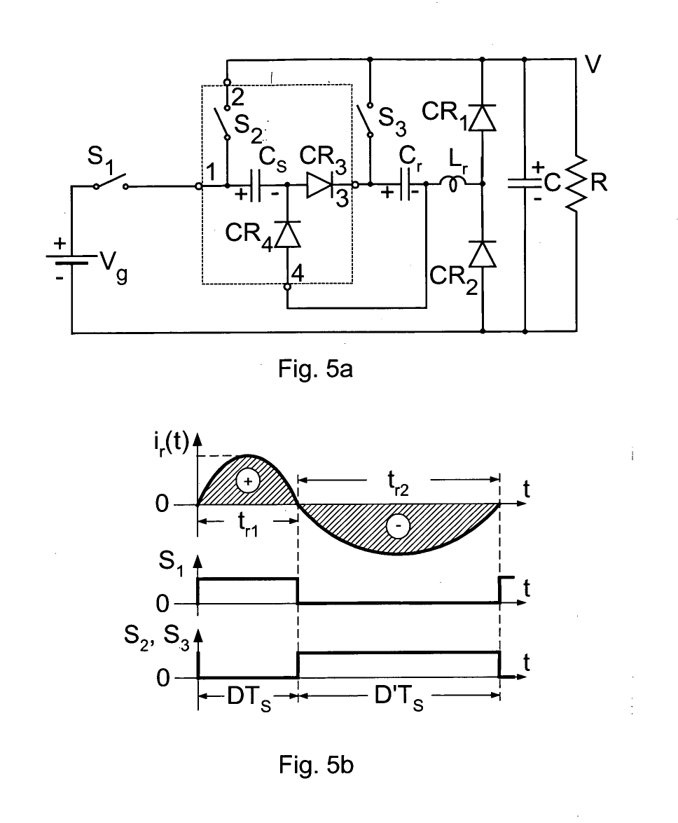

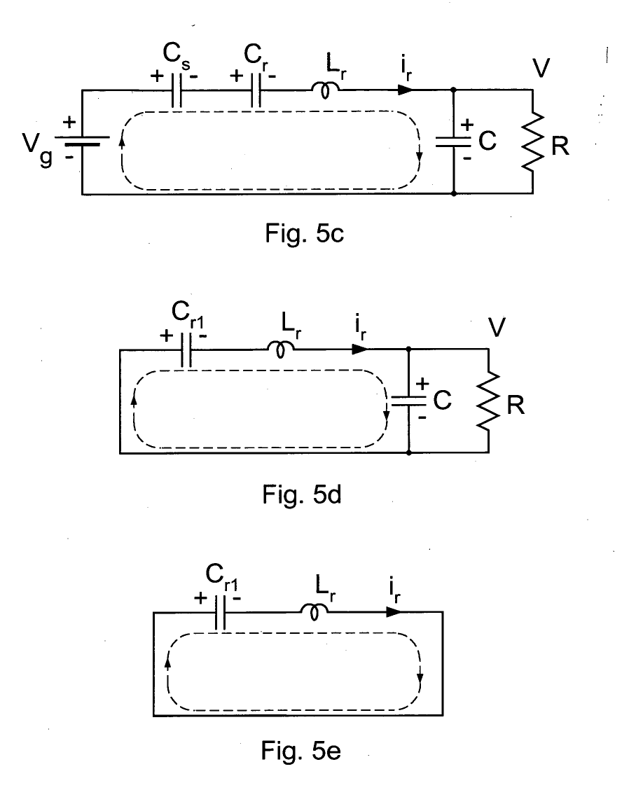

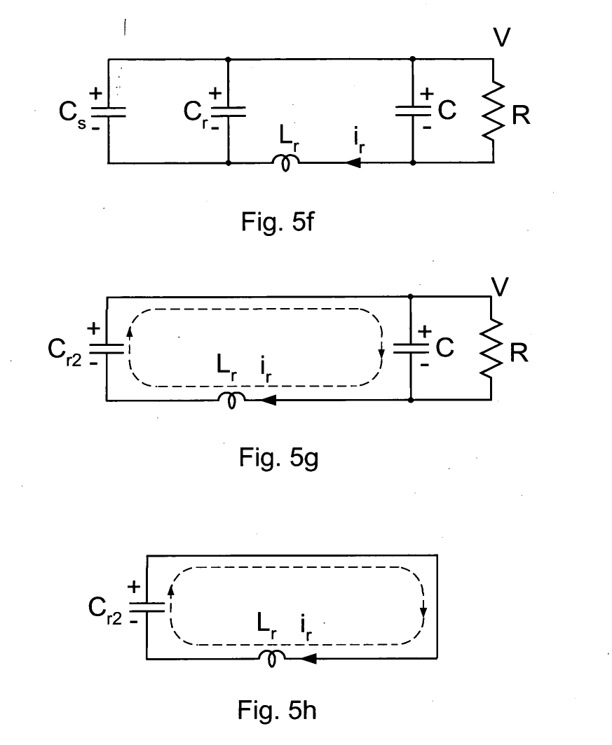

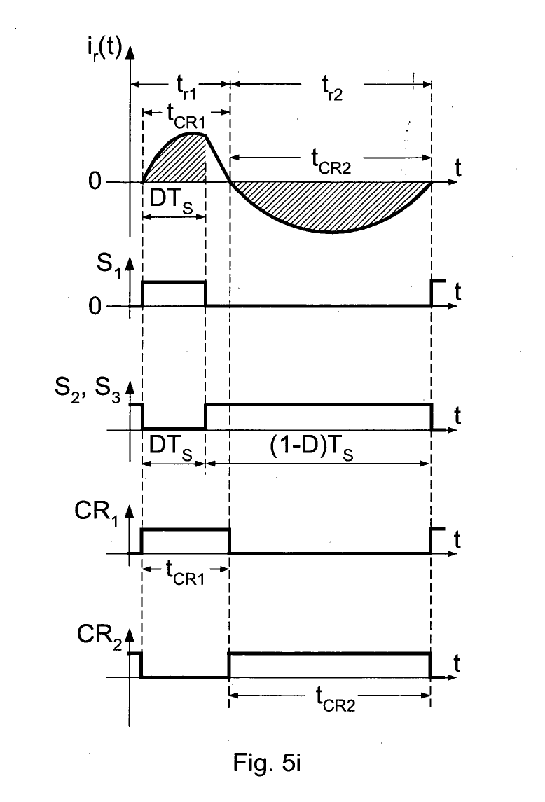

The converter topology of the present invention shown in FIG. 5a consists of three stages connected in series and defined as follows:
a) input stage consisting of an input DC voltage source in series with a controllable switch S₁.
b) four-terminal intermediate switching block with terminals marked 1, 2, 3, and 4, which consists of another controllable switch S₂, and two current rectifiers marked CR₃ and CR₄ as well as a switching capacitor C_{S}, which is marked as a separate block in dotted lines in FIG. 5a and
c) output stage consisting of a complementary switch S₃, resonant capacitor Cᵣ and resonant inductor Lᵣ and first output current rectifier CR₁ and second output current rectifier CR₂.

The above notation is used for the two reasons. First, to facilitate later description of the generalized converter with N to 1 DC voltage step-down, by an introduction of the repeated application of the four-terminal block described above. Second, to facilitate the description of the basic and generalized converter topology for the purpose of the precise definition of the connection of all the components in the converter for the purpose of defining the independent and dependent claims, which are written having in mind this drawing in the specifications. For this reason, the two capacitors are given a different name, one is named switching capacitor C_{S} while the other is named resonant capacitor. Nevertheless, as seen in further analysis, both capacitors are operating as resonant capacitors in conjunction with the above-defined single resonant inductor.

The main controllable switch is input switch S₁, while the two other controllable switches S₂ and S₃ operate in complementary way to this switch as illustrated in switch-state diagram in FIG. 5b.

Furthermore, the current rectifiers CR₃ and CR₁ are forced to turn ON when the input switch S₁ is turned ON and form the first resonant circuit during the ON-time interval as illustrated in FIG. 5c during which the two resonant capacitors C_{S} and Cᵣ are charged in series by the resonant inductor current iᵣ.

Likewise, during the OFF-time interval, when the input switch S₁ is turned-OFF, the current rectifier CR₄ is forced to turn ON when the switch S₂ is turned ON and current rectifier CR₂ is forced to turn ON when the switch S₃ is turned ON thus forming the resonant discharge circuit of FIG. 5f, in which the two resonant capacitors C_{S} and Cᵣ are connected in parallel and discharged through the common resonant inductor Lᵣ connected in series with them to provide the load current.

DC voltage source V_{g} is connected to the input and the DC load R is connected across the output capacitor C. Switches are operated in such a way that when S₁, CR₁ and CR₃ are closed during ON-time interval DT_{S}, switches S₂ and S₃ are open and vice versa as shown in switch states diagram of FIG. 5b. Switching period T_{S} then designates the period of repetitive opening and closing of switches and D is a fractional period relative to the total period during which switch S₁ is closed and switch S₂ open. Therefore, the DC-to-DC converter states alternate between two distinct networks of capacitors and resonant inductor Lᵣ forming effectively two resonant circuits:
a) Circuit for ON-time interval during which capacitors C_{S}, and Cᵣ are connected in series as shown in FIG. 5c and forming with the resonant inductor Lᵣ and output capacitor C an effective first resonant circuit. The sinusoidal-like resonant current supplied from the input voltage source V_{g} is during this ON-time interval charging two resonant capacitors as well as the output capacitor C in series.
b) Circuit for OFF-time interval during which two resonant capacitors are connected in parallel as shown in FIG. 5d. From the energy transfer point of view, each of the capacitors which was charged in previous ON-time interval from the input voltage source is now capable to deliver its stored charge to the output capacitor C and provide ultimately the DC load current I_{L}. Clearly, this is taking place though a second resonant circuit formed with resonant capacitors C_{S} and Cᵣ connected in parallel and then in series with the same resonant inductor Lᵣ and output capacitor C.

Due to repetitive switching a steady state condition is reached every cycle, when charge stored on each of the two resonant capacitors C_{S} and Cᵣ during ON-time interval must be equal to the respective discharge of two resonant capacitors C_{S} and Cᵣ during the OFF-time interval. Simply stated each of the two capacitors C_{S} and Cᵣ must in steady state obey charge balance, that is charge supplied to it must be equal to its discharge to the load. Otherwise, the net positive charge over the cycle would result in violation of steady-state condition and infinite increase of the DC voltage on each capacitor.

### Analysis of the Two Resonant Circuits

We analyze separately each of the two resonant circuits and introduce appropriate analytical equations, which will be used later to introduce the optimal design of the converter.

### First Resonant Circuit

The circuit for ON-time interval shown in FIG. 5c can be reduced to the equivalent circuit of FIG. 5d by replacing the resonant capacitors connected in series with their equivalent value Cᵣ₁:

1/Cᵣ₁=1/C_{S}+1/Cᵣ (4)

The equivalent capacitor Cᵣ₁ is in turn connected in series with the resonant inductor Lᵣ and in series with the parallel connection of the output capacitor C and load resistor R. Although not required for the converter operation, the output capacitor is chosen for practical reasons (further reduction of output ripple voltage in particular as introduced later and to make the resonant frequency fᵣ₁ independent of the load capacitor C) to be significantly larger than the resonant capacitor Cᵣ₁, that is:

C>>Cᵣ₁ (5)

Therefore, the equivalent circuit of FIG. 5d could be further simplified by shorting the output capacitor C to result in the simple series resonant circuit of FIG. 5e. From this circuit we can now define the first resonant frequency fᵣ₁, first resonant period Tᵣ₁ and the half of the first resonant period Tᵣ₁ defined as tᵣ₁, first angular frequency ωᵣ₁ and correlate them to the resonant component values Lᵣ and Cᵣ₁ as:

fᵣ₁=1/Tᵣ₁; tᵣ₁=½Tᵣ₁; ωᵣ₁=2πfᵣ₁=1/√LᵣCᵣ₁ (6)

### Second Resonant Circuit

The circuit for OFF-time interval shown in FIG. 5f can be reduced to the equivalent circuit of FIG. 5g by replacing the capacitors C_{S} and Cᵣ connected in parallel with their equivalent value Cᵣ₂ as per formula:

Cᵣ₂=C_{S}+Cᵣ (7)

The equivalent capacitor Cᵣ₂ is, in turn, connected in series with the resonant inductor Lᵣ and in series with the parallel connection of the output capacitor C and load resistor R. Although not required for the converter operation, the output capacitor is chosen for practical reasons (further reduction of output ripple voltage in particular as introduced later and to make the second resonant frequency fᵣ₂ independent of the load capacitor C) to be significantly larger than the resonant capacitor Cᵣ₂, that is:

C>>Cᵣ₂ (8)

Comparison of the inequalities (5) and (8) reveals that Cᵣ₂ capacitance is larger then Cᵣ₁ capacitance as equivalent capacitance of parallel connection of the capacitors is larger than equivalent capacitance of their series connection thus resulting only in inequality (8) which needs to be satisfied as inequality (5) will then be automatically met.

The equivalent circuit of FIG. 5g could be further simplified by shorting the output capacitor C to result in the simple series resonant circuit of FIG. 5h. From this circuit we can now define the second resonant frequency fᵣ₂, second resonant period Tᵣ₂ and second angular frequency ωᵣ₂ and correlate them to the resonant component values Lᵣ and Cᵣ₂ as:

fᵣ₂=1/Tᵣ₁; tᵣ₂=½Tᵣ₂; ωᵣ₂=2πfᵣ₂=1/√LᵣCᵣ₂ (9)

Note, however, that the resonant inductor current iᵣ could, in general, in each of the two switching intervals (ON-time interval and OFF-time interval), flow in either direction as it is a nature of the resonant circuit to conduct the sinusoidal like current in either positive or negative direction. This is, however, prevented by the two output current rectifiers CR1 and CR₂. During the ON-time interval current rectifier CR₁ allows only a positive resonant current flow to the output. During the OFF-time interval current rectifier CR₂ allows also only a positive resonant current to flow to the load. Note that the resonant inductor current iₜ does consist of the positive current flow illustrating charging of the capacitors in series, but that it also has a negative part illustrating discharge of the same capacitors into the DC load as seen in the resonant current waveform shown in FIG. 5b. Note also that during the OFF-time interval the total resonant inductor discharge current is actually flowing into the load as a positive load current. Therefore, the load current is the sum of the resonant charge current during ON-time interval and resonant discharge current during the OFF-time interval, so that:

i_{L}(t)=iᵣ(ON-time)+iₜ(OFF-time) (10)

i_{g}(t)=iᵣ(ON-time) (11)

where i_{g}(t) is the input current.

### Fixed 3 to 1 DC Voltage Step-down

First the operation of the converter in FIG. 5a is described with the reference to the special controllable switch drive waveforms shown in FIG. 5b and the resonant inductor current iₜ is also shown under those special conditions. For this special case of controllable switch drives given by:

DT_{S}=tᵣ₁ (1−D)T_{S}=tᵣ₂ (12)

in which the ON-time interval is made to be equal to the half of the first resonant period and the OFF-time interval is made equal to the half of the second resonant period the total switching period T_{S} consist of the sum of the two half resonant periods with no zero coasting intervals in-between, as illustrated by the resonant inductor current FIG. 5b. Presence of zero coasting interval would only lead to reduced efficiency as described later.

Such optimum resonant current flow can be secured by choosing the resonant periods, Tᵣ₁ and Tᵣ₂, to satisfy the following conditions:

0.5Tᵣ₁=DT_{S} (13)

0.5Tᵣ₂=(1−D)T_{S} (14)

where switching period T_{S} satisfies:

T_{S}=0.5(Tᵣ₁+Tᵣ₂) (15)

and f_{S}=1/T_{S} (16)

where f_{S} is the switching frequency.
Finally, another useful analytical relationship can be derived as:

1/f_{S}=0.5(1/fᵣ₁+1/fᵣ₂) (17)

that the switching frequency is a mean (17) of the two resonant frequencies. For example, for fᵣ₁=100 kHz and fᵣ₂=50 kHz switching frequency f_{S} is evaluated from (17) to be f_{S}=66 kHz.

In this special case, the total resonant current discharged to the load during the whole period is three times larger than the resonant charge current taken from the DC input voltage source during ON-time interval, resulting in 3 to 1 respective DC current conversion ratio from output to input. Therefore, the DC voltage conversion ratio from input DC source to output DC load must be the same resulting in 3 to 1 step-down voltage conversion ratio.

### Continuous Output DC Voltage Step-Down

One would now assume that this invention is limited to the fixed DC voltage step-down. This, however, is not the case, due to the special role played by the two output current rectifiers CR₁ and CR₂.

We will first examine the special role played by the first current rectifier CR₁ in providing the continuous reduction of the output DC voltage below ⅓ when the duty ratio D is not fixed at D=⅓ as in the above example, but is actually reduced below that value. Thus, conditions for continuous DC output voltage reduction is given by:

t_{ON}=DT_{S}<tᵣ₁ (18)

where the ON-time interval t_{ON} is being modulated by the duty ratio D and OFF-time interval t_{OFF} is kept constant, that is:

t_{OFF}=(1−D)T_{S}=tr₂=constant (19)

Clearly, the switching frequency in addition to duty ratio D is also variable. However, the variable switching frequency is not required and it will be demonstrated in later sections how this condition could be removed.

Note that an analogous and alternative option for continuous reduction of the output DC voltage exists if one were to modulate the OFF-time interval. However, this case will not be analyzed in details here.

The same converter of FIG. 5a is now operated with the variable ON-time interval and constant OFF-time interval. As shown in switch-state diagram of FIG. 5i the three controllable switches S₁, S₂ and S₃ operate as before in a complementary fashion to each other. Note also that the second current rectifier CR₂ operates in a complementary way to the first current rectifier CR₁, and can only be turned ON after the first current rectifier CR₁ is turned OFF. In addition, the second current rectifier CR₂ conduction time is constant and equal to half the resonant period of second resonant circuit as defined earlier.

The first current rectifier conduction time is, however, now being modulated by the duty ratio and reduced below the half of the first resonant period. Note also that the first current rectifier CR₁ continues to conduct even after the input switch S₁ is turned OFF until the current in resonant inductor is reduced to zero, as seen in resonant inductor current waveform of FIG. 5i. As it will be shown in later sections and in experimental verification, it is this modulation of the shape of the current waveform of the conduction time of the first current rectifier that provides the continuous change of the DC current conversion ratio and therefore results in the corresponding continuous output DC voltage change.

Generalized Converter with N-Stages

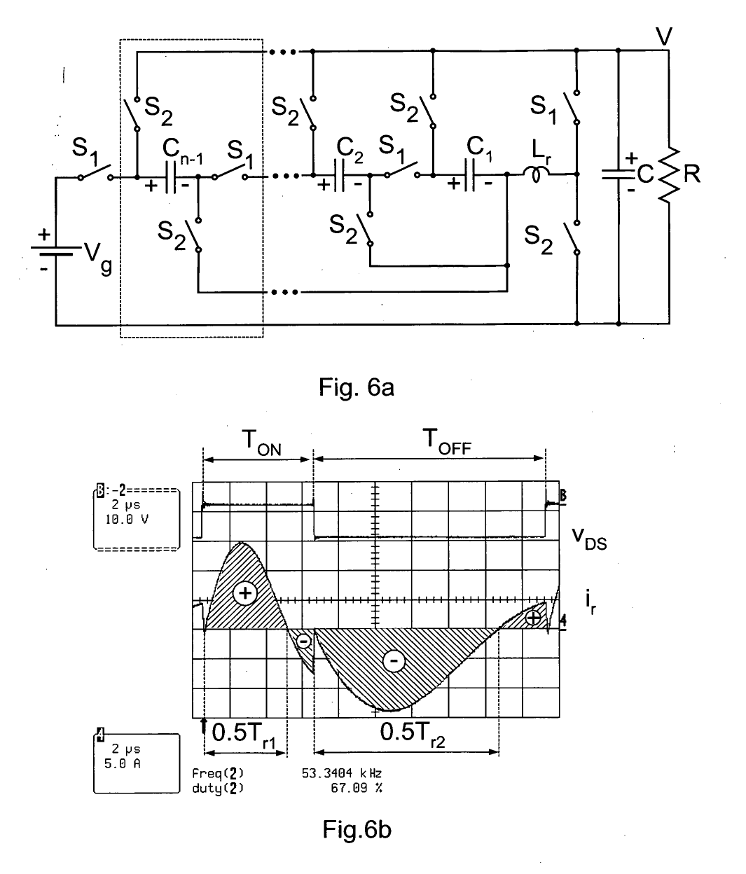

We now use the four-terminal block defined with respect to converter in FIG. 5a to generate the converter in FIG. 6a in which this four terminal block is inserted N times and analyze this converter. To emphasize the importance of the current rectifiers CR₁ and CR₂ for the operation of the converter, they are temporarily replaced with the controllable switches S₁ and S₂, which are switching in complementary way to each other.

Note, however, that the resonant inductor current iₜ could now in each of the two switching intervals (ON-time interval and OFF-time interval), flow in either direction as it is a nature of the resonant circuit to conduct the sinusoidal like current in either positive or negative direction. Thus, contrary to the assumption made in the previous section describing the basic operation of the converter in which ON-time interval is supposed to be capacitor charging interval only, this may not be the case if the component values and operating conditions (duty ratio and switching frequency f_{S}) were not chosen properly.

One such sub-optimal choice of the component values and operating conditions resulted in the experimental waveform of the resonant inductor current recorded in FIG. 6b. The resonant current iₜ is shown to flow during ON-time interval in either direction. Positive resonant current direction during this ON-time interval resulted in the charge stored on capacitors (corresponding area under inductor current marked with positive sign). However, as the resonant current changed to opposite direction, the capacitors were also partially discharged during the same ON-time interval (corresponding area under inductor current marked with negative sign for partial discharge). Note also that during ON-time interval, the stored charge (area marked positive) is apparently larger than the discharge area, so that during this interval net charge stored on the capacitor is the difference between two areas. However, the point is that such an operation is clearly undesirable for the efficiency and best utilization of the components. As we will see later it also results in having switches operate with high switching losses instead of eliminating switching losses.

The same conclusion is reached for the OFF-time interval, which could as seen in FIG. 6b result in wasteful discharge interval, although the net charge provided to the load would still be positive supplying the load. Thus, such operation in this interval should be avoided as well.

Clearly, this can be avoided by allowing only positive current flow during the ON-time interval (hence only charging capacitors) and only allowing discharge of capacitors to the load during the OFF-time interval. This, in turn, can be accomplished by allowing that during each interval, only appropriate half of the resonant current is allowed to flow: positive current for ON-time interval and negative (reverse) current flow during OFF-time interval.

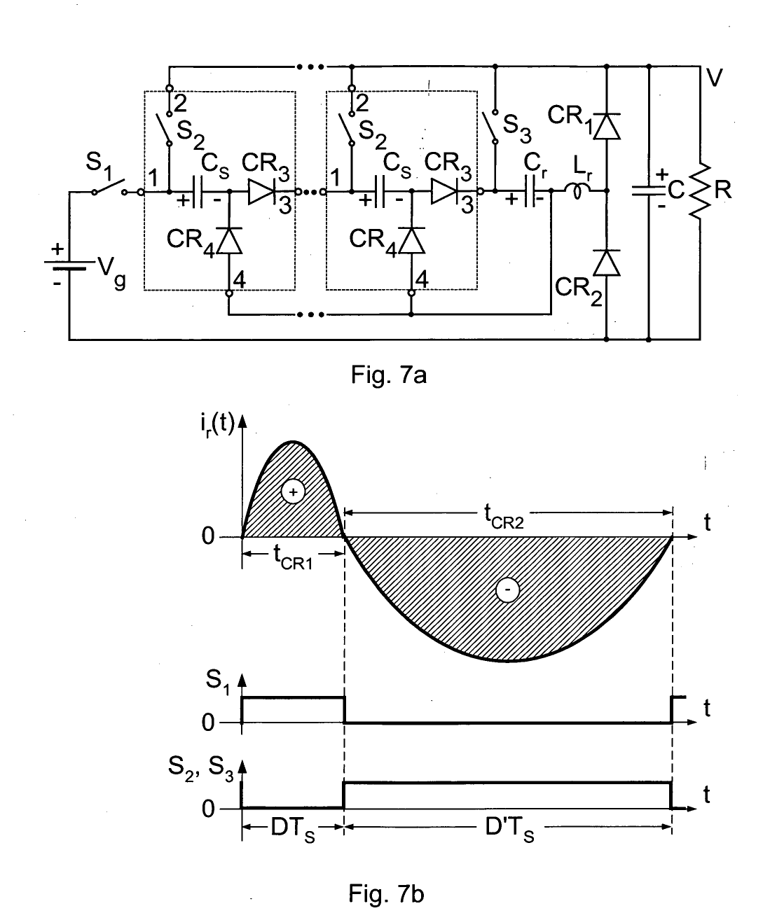

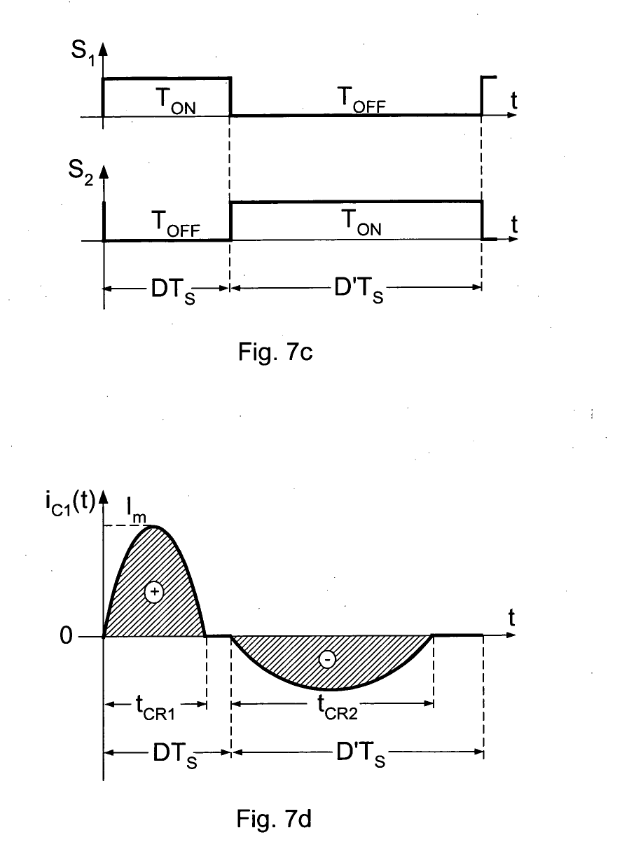

Therefore, we now restore the generalized converter as in FIG. 7a with two current rectifiers CR₁ and CR₂. Note also, that the minimum switch implementation shown in FIG. 7a uses current rectifiers CR₃ and CR₄ in each four terminal block and one controllable switch per each four-terminal block to minimize the number of controllable switches. Clearly, when the need arises to reduce the conduction losses of the current rectifiers in low voltage applications, the current rectifiers CR₃ and CR₄ can be replaced with the MOSFET switching devices operated as synchronous rectifiers. Finally, the current rectifiers CR₁ and CR₂ can also be replaced with synchronous rectifier MOSFETs. In that case, however, these MOSFETs must have the same conduction times as their internal body diodes, in order to prevent the negative flow of the inductor resonant currents illustrated in FIG. 6b.

### Analysis of the Two Generalized Resonant Circuits

We analyze separately each of the two resonant circuits of the converter in FIG. 7a and introduce appropriate analytical equations, which will be used later to introduce the optimal design of the converter.

### First Resonant Circuit

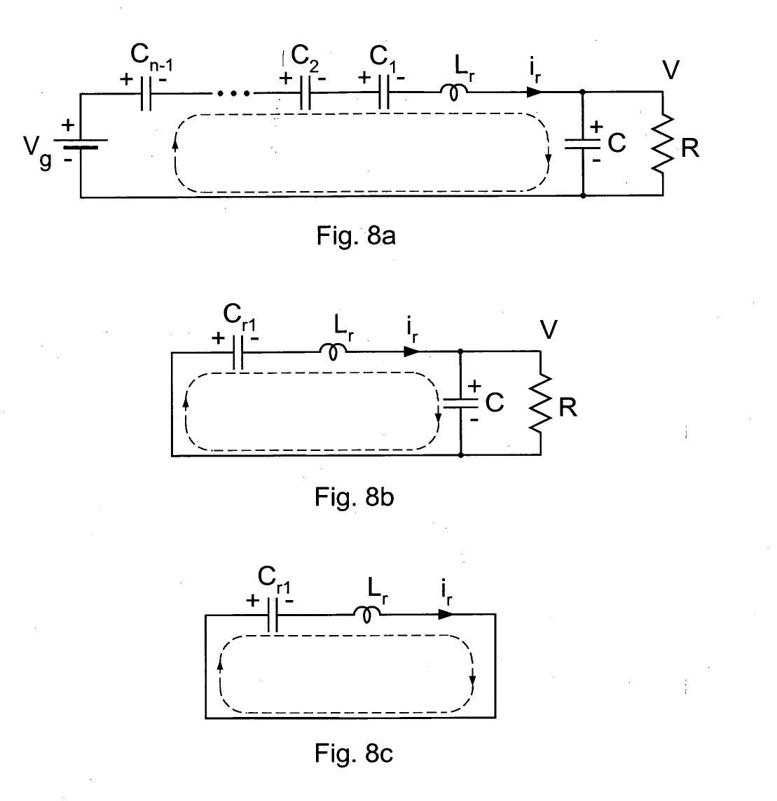

The circuit for ON-time interval shown in FIG. 8a can be reduced to the equivalent circuit of FIG. 8b by replacing the capacitors C₁, C₂ through Cₙ₋₁ in series with their equivalent value Cᵣ₁:

1/Cᵣ₁=1/C₁+1/C₂+ . . . +1/Cₙ₋₁ (20)

The equivalent capacitor Cᵣ₁ is, in turn, connected in series with the resonant inductor Lᵣ and in series with the parallel connection of the output capacitor C and load resistor R. Although not required for the converter operation, the output capacitor is chosen for practical reasons (further reduction of output ripple voltage in particular as introduced later and to make the resonant frequency fᵣ₁ independent of the load capacitor C) to be significantly larger than the resonant capacitor Cᵣ₁, that is:

C>>Cᵣ₁ (21)

Therefore, the equivalent circuit of FIG. 8b could be further simplified by shorting the output capacitor C to result in the simple series resonant circuit of FIG. 8c. From this circuit we can now define the first resonant frequency fᵣ₁, first resonant period Tᵣ₁ and first angular frequency ωᵣ₁ and correlate them to the resonant component values Lᵣ and Cᵣ₁ as:

fᵣ₁=1/Tᵣ₁ ωᵣ₁=2πfᵣ₁=1/\sqrt{LᵣCᵣ₁} (22)

### Second Resonant Circuit

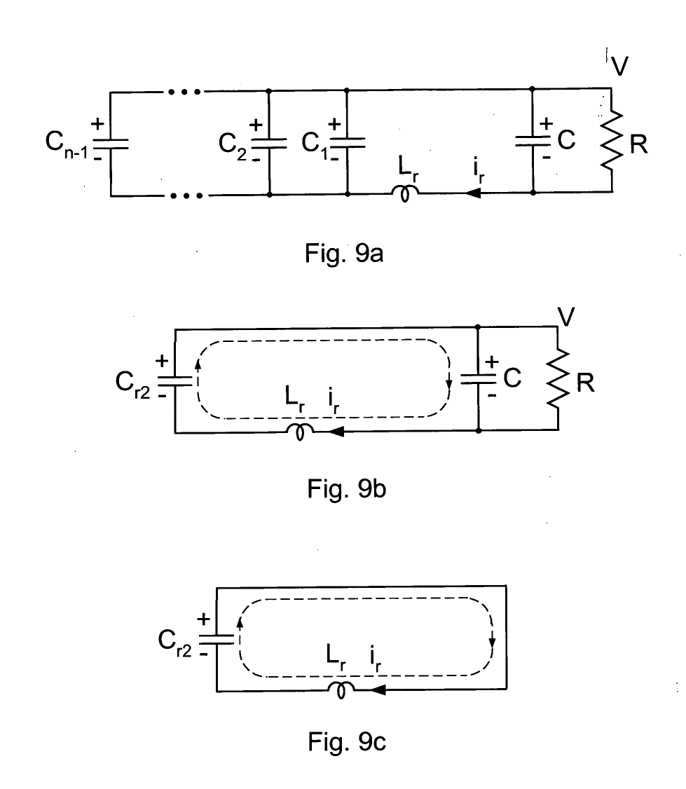

The circuit for OFF-time interval shown in FIG. 9a can be reduced to the equivalent circuit of FIG. 9b by replacing the capacitors C₁, C₂ through Cₙ₋₁ connected in parallel with their equivalent value Cᵣ₂ as per formula:

Cᵣ₂=C₁+C₂+ . . . +Cₙ₋₁ (23)

The equivalent capacitor Cᵣ₂ is in turn connected in series with the resonant inductor Lᵣ and in series with the parallel connection of the output capacitor C and load resistor R. Although not required for the converter operation, the output capacitor is chosen for practical reasons (further reduction of output ripple voltage in particular as introduced later and to make the second resonant frequency fᵣ₂ independent of the load capacitor C) to be significantly larger than the resonant capacitor Cᵣ₂, that is:

C>>Cᵣ₂ (24)

Comparison of the inequalities (21) and (24) reveals that Cᵣ₂ capacitance is larger then Cᵣ₁ capacitance as equivalent capacitance of parallel connection of the capacitors is larger than equivalent capacitance of their series connection thus resulting only in inequality (24) which needs to be satisfied as inequality (21) will then be automatically met.

The equivalent circuit of FIG. 9b could be further simplified by shorting the output capacitor C to result in the simple series resonant circuit of FIG. 9c. From this circuit we can now define the second resonant frequency fᵣ₂, second resonant period Tᵣ₂ and second angular frequency ωᵣ₂ and correlate them to the resonant component values Lᵣ and Cᵣ₂ as:

fᵣ₂=1/Tᵣ₂ ωᵣ₂=2πfᵣ₂=1/\sqrt{LᵣCᵣ₂} (25)

Note that under these conditions, resonant inductor will have a current as shown in FIG. 7b which now insures that the ON-time interval is only capacitors charging interval and OFF-time is only capacitors discharging interval. This will clearly result in more efficient operation. There is also one added benefit, visible in FIG. 7b. All resonant capacitor currents will go through zero current level at precisely the switching instances. Therefore, all diode switches will both turn ON and turn OFF at zero current level thus eliminating switching losses. From standpoint of the reliability this is also most desirable, since all the switches are least stressed at critical switching instances. Such elimination of switching losses clearly further boosts the conversion efficiency.

### Basic DC Current and DC Voltage Conversion Ratios

The resonant current through each of the capacitors C₁ through Cₙ₋₁ is composed of the two parts as illustrated in FIG. 7d, each part starting and ending at zero current level. The two areas under the capacitor current waveforms in FIG. 7d, represent the respective charge Q stored on each capacitor (shaded area marked positive) during ON-time interval and equal discharge part (shaded area marked negative) during the subsequent OFF-time interval.

The recognition of this charge balance on (n−1) capacitors of FIG. 7d leads directly to a simple derivation of the basic DC current conversion ratio. The DC source current is equal to the charge Q spread over the period T_{S}, that is:

I_{g}=QT_{S} (26)

On the other hand, (n−1) charge transfer capacitors are releasing (n−1) Q charge to the load during OFF-time interval, as each capacitor is connected in parallel and discharging to the load. Note, however, that the load is also receiving an additional charge Q directly from the source during the charging ON-time so that the total charge received by the load during both intervals is nQ (the sum of the ON-time and OF-time charges received) thus resulting in DC load current

I_{L}=nQT_{S} (27)

from which we can derive DC current conversion ratio as

I_{L}/I_{g}=n (28)

The extra benefit of this method is that the output current is quasi-continuous, that is always flowing to the load (during both intervals). The direct consequence of absence of the interval during which no charge is delivered to the load results in favorable low ripple current and consequent low ripple voltage on the output.

The presence of the single resonant inductor Lᵣ results in the transfer of power from input to output in a lossless manner. Thus, if the components are ideal, such as switches with zero conduction and zero switching losses, capacitors with zero ESR (Equivalent Series Resistance) and inductor with zero copper losses, an ideal 100% efficiency would be obtained. Thus, invoking this 100% efficiency argument, we can derive the ideal DC voltage conversion ratio from DC current conversion ratio (28) as opposite to current conversion ratio or:

V/V_{g}=1/n (29)

The ideal DC conversion gain in (29) results in fixed integer DC conversion ratios providing the discrete voltage step-downs equal to integer ratios, such as 3:1 for n=3 or 12:1 for n=12.

Thus, the large DC voltage step-down can be made with high conversion efficiency, since the above mentioned non-idealities are second order parasitic elements and can be much reduced to result in efficiencies of over 99% and ability to process the high power of tens and hundreds of kilowatts efficiently.

The conversion ratio given by (29) also suggest that only discrete conversion ratios can be achieved similarly to switched capacitor converters and that no continuous control of the output voltage could be provided. This is not the case as the later section demonstrates a number of effective methods to provide a continuous regulation of output voltage in addition to the above discrete control.

### Requirement Imposed On Resonant Capacitor Values

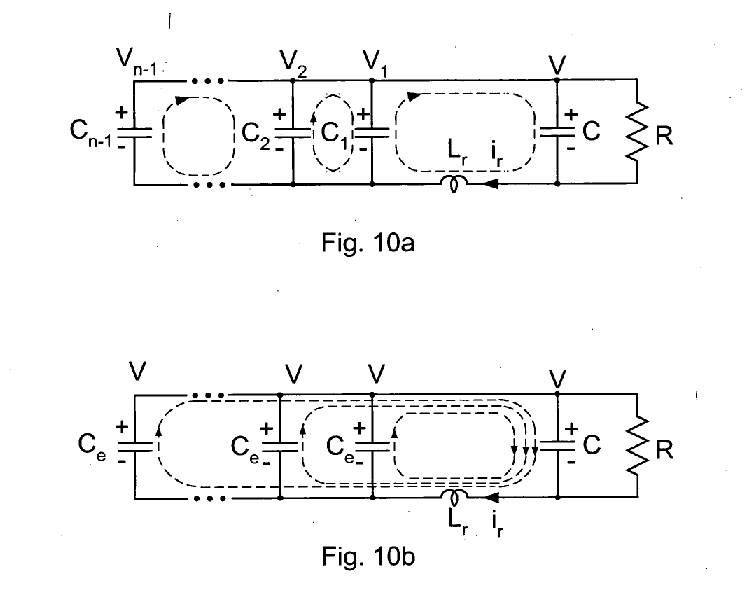

It may appear that the high efficiency is secured even for an arbitrary choice of the charge transfer capacitors C₁, C₂ through Cₙ₋₁. This is however, not the case, as obvious from the circuit diagram of FIG. 10a when all charge transfer capacitors have widely different values.

The typical resonant capacitor current in the i-th capacitor Cᵢ shown in FIG. 8b to consist of the positive sinusoidal charge current during ON-time charge interval DT_{S}=0.5Tᵣ₁ and of negative sinusoidal discharge current during the interval (1−D)T_{S}=0.5Tᵣ₂. Note that the two areas must be equal in steady-state. The two intervals are clearly different in length due to a single resonant inductor forming a resonant current first with the series of capacitors to result in half-resonant period 0.5Tᵣ₁ and then with the same capacitors in parallel, to result in another half-resonant period 0.5Tᵣ₂. Clearly, the area under the resonant current waveform is the total charge Q either stored or released from the capacitor Cᵢ during the complete switching period T_{S}. From fundamental relationship between DC voltage V; and the charge stored on capacitors Cᵢ we have:

Vᵢ=Q/Cᵢ for i=1, 2, . . . (n−1) (30)

Thus, widely different capacitor values Cᵢ would result in widely different voltages Vᵢ on capacitors. Thus, when all charge transfer capacitors are connected in parallel as in circuit of FIG. 10a there will be circulating currents flowing between all these capacitors in an attempt to equalize the voltages on individual capacitors during the OFF-time interval. Clearly such circulating current would result in undesired extra loss and reduction of efficiency.

This problem, however, can be fixed very easily by imposing the requirement that all charge transfer capacitors have equal values that is:

C₁=C₂= . . . =Cₙ₋₁=Cₑ (31)

and

Cᵣ₁=Cₑ/(n−1) (32)

and

Cᵣ₂=(n−1)Cₑ (33)

Under such conditions the DC voltages on charge transfer capacitors will from (20) be equal to V where V is given by:

V=Q/Cₑ (34)

Clearly, the resulting converter circuit during OFF-time interval shown in FIG. 10b, has DC voltages equal to output DC voltage V, thus eliminating the undesirable circulating currents.

### Voltage Conversion Ratio Dependence On Duty Ratio

We established that the discrete DC voltage conversion ratio (29) is dependent on the total number of capacitors (n) being charged in series: the (n−1) charge transfer capacitors and output capacitor C. Thus, the higher DC voltage step-down required, the bigger is the number of capacitors charged in series. We now derive an alternative analytical expression to the DC conversion ratio (29) but this time expressed in terms of the operating duty ratio D. From (13) and (14) we have:

0.5Tᵣ₂/0.5Tᵣ₁=(1−D)/D (35)

Now we also take into account the desirable equal capacitor values condition given by (31). From (22) and (25) we obtain:

$$\begin{matrix}{T}_{r 1} = 2 π \sqrt{\frac{{L}_{r} {C}_{e}}{n - 1}} & ( 36 ) \\ {T}_{r 2} = 2 π \sqrt{{L}_{r} {C}_{e} ( n - 1 )} & ( 37 )\end{matrix}$$

and dividing (37) by (36) we get:

Tᵣ₂/Tᵣ₁=n−1 (38)

Replacing (38) into (35) we finally get:

1/n=D (39)

or an alternative DC voltage conversion to that in (29) expressed in terms of duty ratio D:

V/V_{g}=D (40)

It is interesting to note that this DC conversion ratio is identical to that of the buck converter given by (1).

The above equation (40) does not imply that the continuous control of the output voltage is realized. It simply states that the discrete conversion ratios given by (29) can be also interpreted as particular special discrete values of the duty ratio D for which a very desirable performance of zero current crossing for all switches is obtained. Thus, for example, in a converter with n=2, capable of 3:1 fixed step-down conversion ratio, the duty ratio D should be adjusted to D=⅓ in order to get the beneficial zero current crossing of all the switches. Like wise for 4:1 step-down converter a duty ratio should be adjusted to D=¼ and so on. However, later section introduces an entirely new method how to achieve the continuous control of the output DC voltage by duty ratio control, analogous to that of Conventional converters.

### Detailed Analysis of the Two Resonant Circuits

Even though the converter of present invention shown in FIG. 6a has a single inductor, we can clearly distinguish two separate resonant circuits each applicable in the appropriate switching interval. First we will derive the resonant equations for the ON-time interval.

### First Resonant Circuit Model

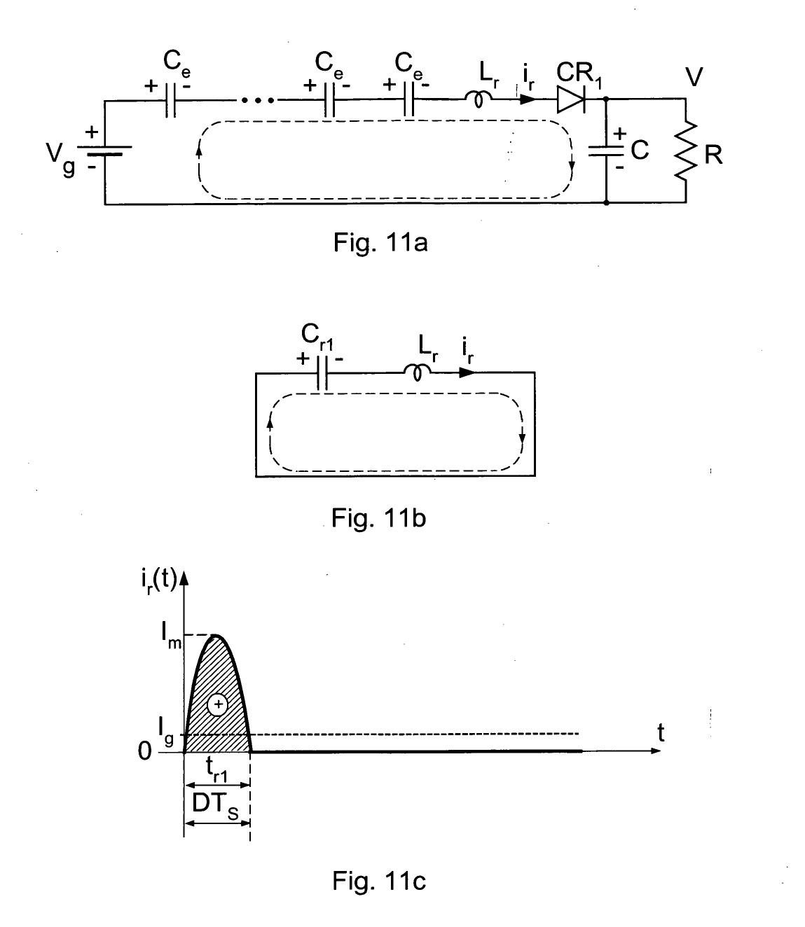

The resonant circuit shown in FIG. 11a is further reduced to the simple resonant circuit of FIG. 11b. The time domain of the resonant current through each capacitor and resonant voltage on each capacitor can then be obtained by solving the resonant circuit in FIG. 11b for resonant current through each capacitor as well as the corresponding resonant voltage on each resonant capacitor to obtain:

iᵣ₁(t)=I_{P} sin(ωᵣ₁t) (41)

From the resonant circuit we have:

Lᵣdiᵣ₁/dt=−Δvᵣ₁ (42)

whose solution is:

vᵣ₁(t)=−Δvᵣ₁ cos(ωᵣ₁t)=−R_{N1}Iₘ cos(ωᵣ₁t) (43)

where

$${R}_{N 1} = \sqrt{\frac{{L}_{r}}{{C}_{r 1}}} \qquad ( 44 )$$

is a natural resistance of the first resonant circuit and Δvᵣ₁ is the AC ripple voltage on resonant capacitor during ON-time interval and given by

Δvᵣ₁=R_{N1}Iₘ (45)

What remains is to correlate yet unknown value of the peak resonant current Iₘ to the DC load current I_{L}. This is derived after both resonant circuits solutions are obtained and solved.

Clearly, the resonant capacitor current can be shown in time domain as in FIG. 11c to consist of only positive one-half of the full sine wave resonant current as the negative part is prevented by implementation of the current rectifiers CR₁ and CR₂.

### Second Resonant Circuit Model

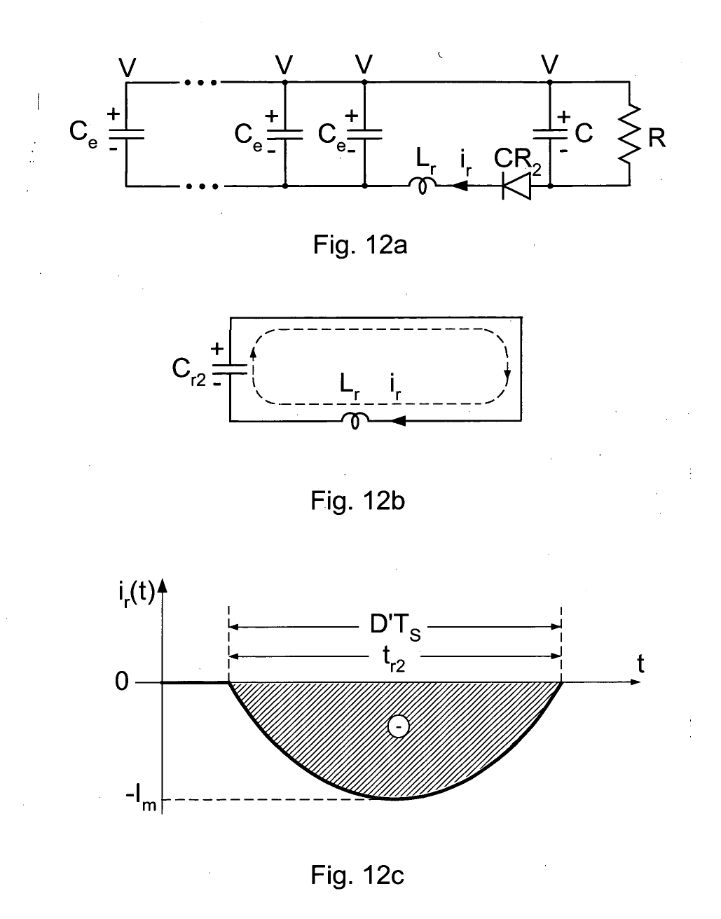

The second resonant circuit with resonant capacitors in parallel shown in FIG. 12a is further reduced to the simple resonant circuit of FIG. 12b. The resonant current through each resonant capacitor and resonant voltage on each capacitor can be obtained by solving the resonant circuit in FIG. 12b to obtain:

i_{ci}(t)=Iₘ₂ sin(ωᵣ₂t) (46)

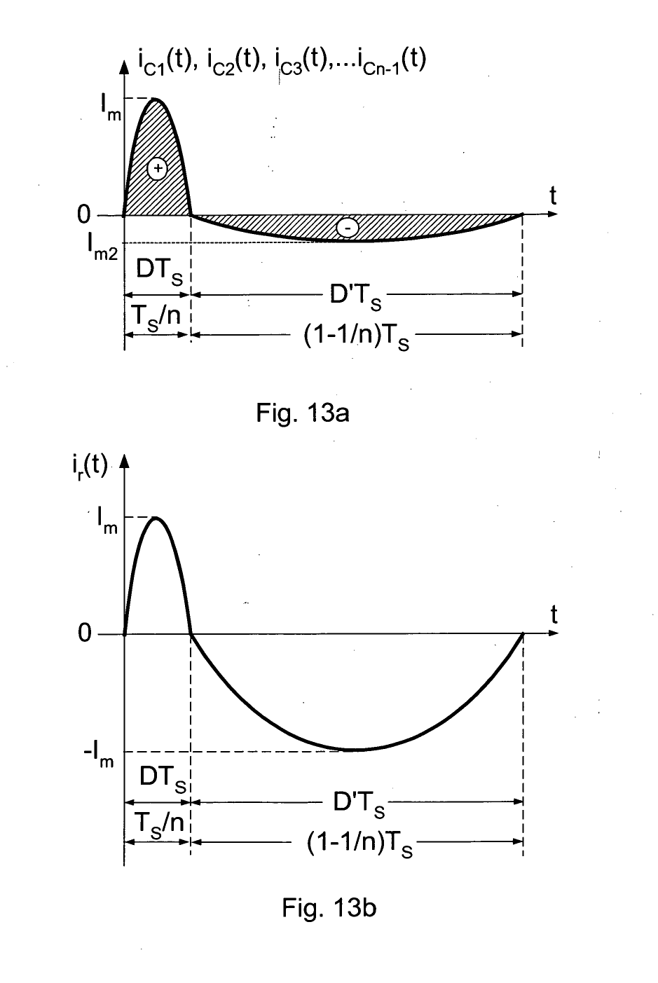

The complete resonant capacitor currents for each of the resonant capacitors C₁, C₂, . . . Cₙ₋₁ for both ON-time and OFF-time are shown in FIG. 13a. As each resonant capacitor current must individually satisfy the charge balance as shown by shaded areas in FIG. 13a, we can use this condition to correlate the peak of the discharge currents Iₘ₂ with the peak of the charging currents Iₘ as:

Iₘ₂=Iₘ/(n−1) (47)

since the ratio of the peaks during two interval is equal to the ratio of their respective intervals to satisfy charge balance equations. Note, however, that the resonant inductor current during OFF-time intervals consists of the sum of (n−1) discharge capacitor currents, that is:

iᵣ₂=i_{C1}+i_{C2}+ . . . +i_{C(n-1)} (48)

which for identical capacitor values results in:

iᵣ₂=(n−1)Iₘ₂ sin(ωᵣ₂t)=Iₘ sin(ωᵣ₂t) (49)

Thus, a very important and beneficial result for ripple current and ripple voltage performance is obtained as also illustrated by the resonant inductor current waveform during both intervals shown in FIG. 13b with equal Iₘ peak in both intervals. The FIG. 14a shows the input and output part of the converter with respective marking for the input and output currents. The two current rectifiers of the output stage rectify the resonant inductor current of FIG. 13b into an output current shown in FIG. 14c.

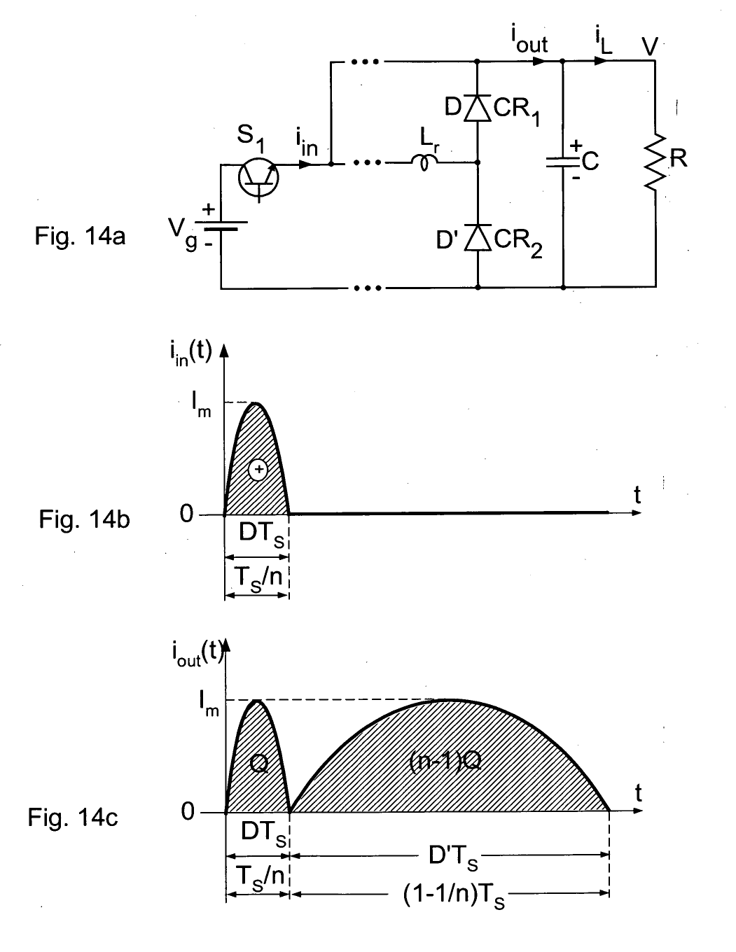

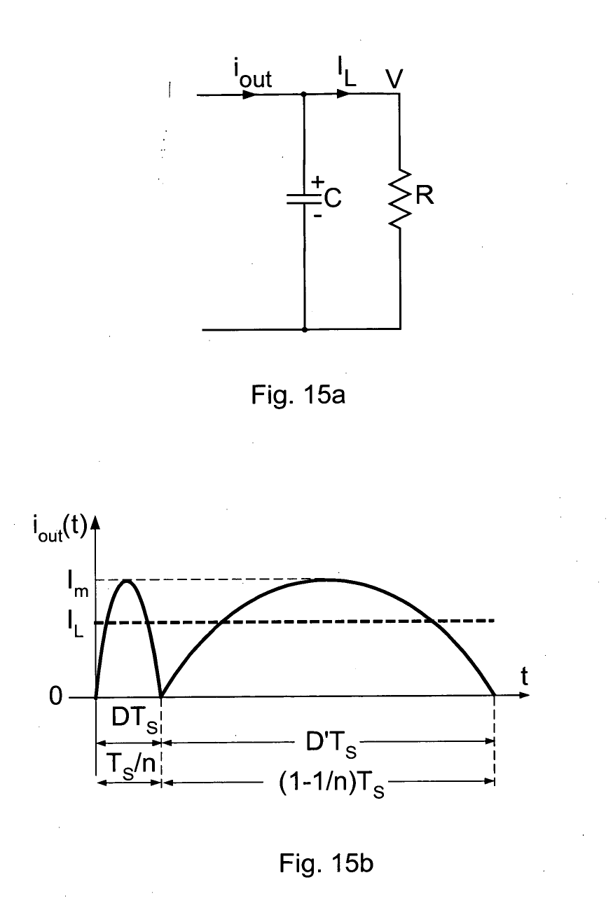

What remains is to correlate the peak resonant current Iₘ to the DC load current I_{L}, which is derived after both resonant circuits are solved. This can be accomplished with the help of output circuit shown in FIG. 15a which illustrates that the pulsating iₒᵤₜ current is filtered out into a DC load current I_{L} with the ripple current being absorbed by the output capacitor C. Using a well-known formula which correlates the peak of the half sinusoidal waveform with its DC average we have:

Iₘ=½πI_{L} (50)

which is approximately 1.5 times the DC load current. The resonant ripple voltage of (34) becomes

Δvᵣ₁=R_{N1}½πI_{L} (51)

We finally find the AC voltage ripple on resonant inductor during second resonance as:

Δvᵣ₂=½R_{N2}πI_{L} (52)

Dividing (40) by (41) we obtain useful correlation:

Δvᵣ₁=(n−1)Δvᵣ₂ (53)

### Transient Response Advantages

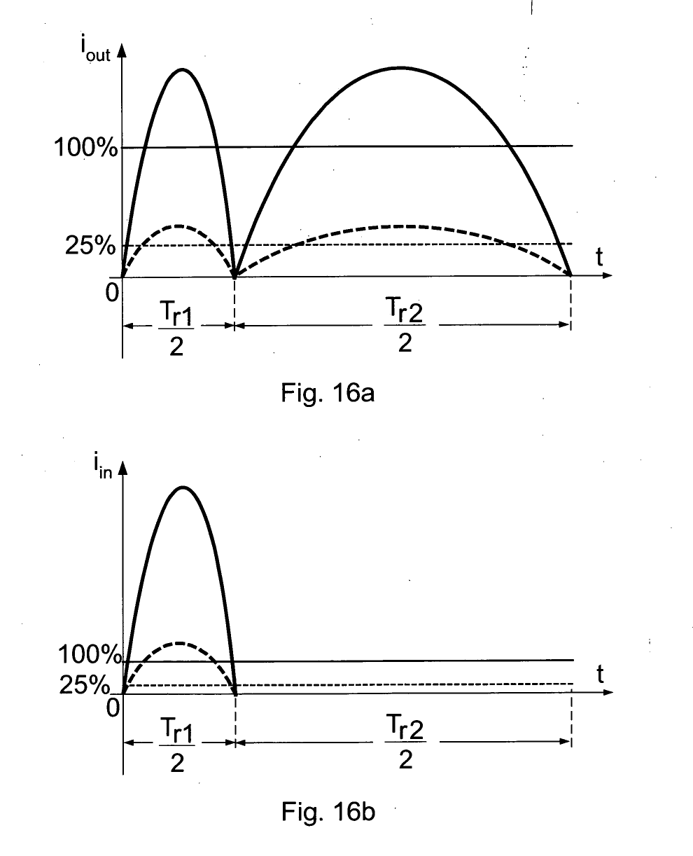

The inductor current of the buck converter shown in FIG. 2a never returns to zero as its AC ripple current is superimposed on large DC bias current. This therefore requires as shown in FIG. 2b a large number of cycles before the inductor instantaneous current is settled to the new steady-state with new DC load current I_{L}. The output current in present invention is the rectified resonant inductor current and therefore returns to zero every cycle. As seen for the waveforms of the output current in FIG. 16a the sudden demand of the DC load current from 25% to 100% is met with the corresponding increase on a single cycle basis of the output current from 25% (dotted lines) to 100% (heavy lines). The load current demand is once again met with the corresponding input current change on a single cycle basis as seen in FIG. 16b with 25% (dotted lines) to 100% (heavy lines) input current change. This theoretical prediction is confirmed with experimental measurement data made on a prototype and included in experimental section.

### Conversion Efficiency and Elimination of Switching Losses

Note that during the DT_{S} interval the resonant capacitors are charging from input source directly with the DC input current. On the other hand, during the D′T_{S} interval, the same capacitors, which were charged in previous interval, are now discharging in parallel directly into load. Therefore, capacitors charging and discharging is used to effectively supply the load current at all times so that load current is quasi-continuous therefore reducing the output ripple voltage and minimizing filtering requirements.

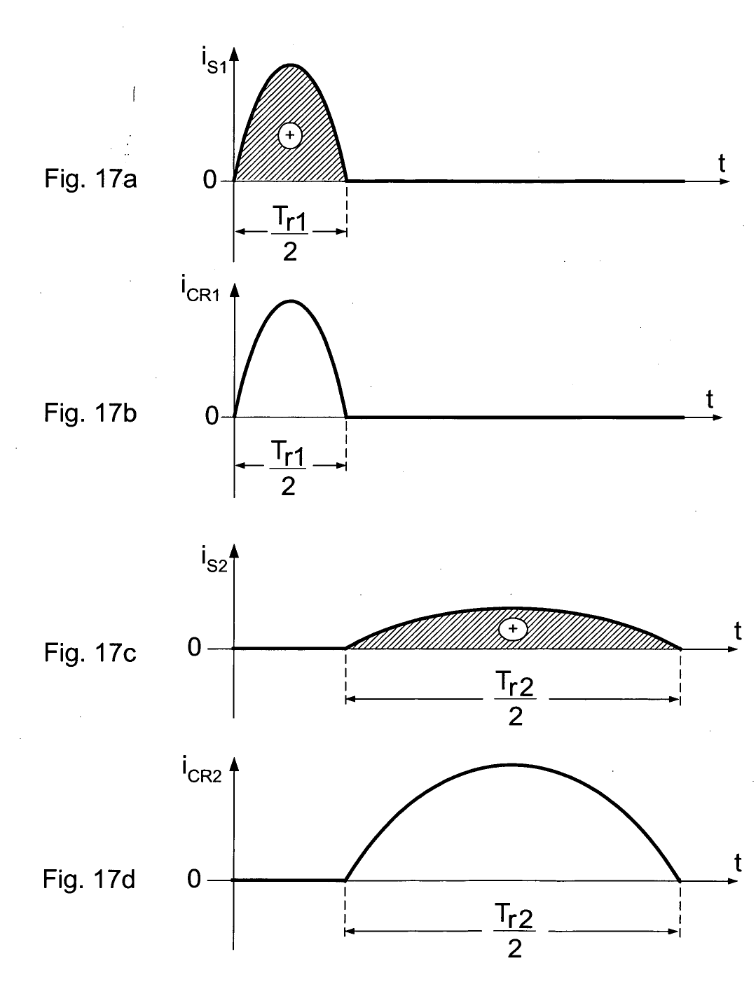

The resonant charge and discharge of the capacitors has also another benefit for conversion efficiency since all the switches in the converter of Fig. ca are switching under ideal conditions at zero current, so they have both turn ON at zero current and turn OFF at zero current. FIG. 17a shows zero current switching of all S₁ switches while FIG. 17b shows the same for the current in current rectifier CR₁. FIG. 17c shows zero current switching of all S₂ switches while FIG. 17d shows the same for the current in current rectifier CR₂., Clearly, such operation of switches is also one of reasons for ultra efficient operation of the present invention in addition to extremely small size of the converter.

### Minimum Switch Implementation

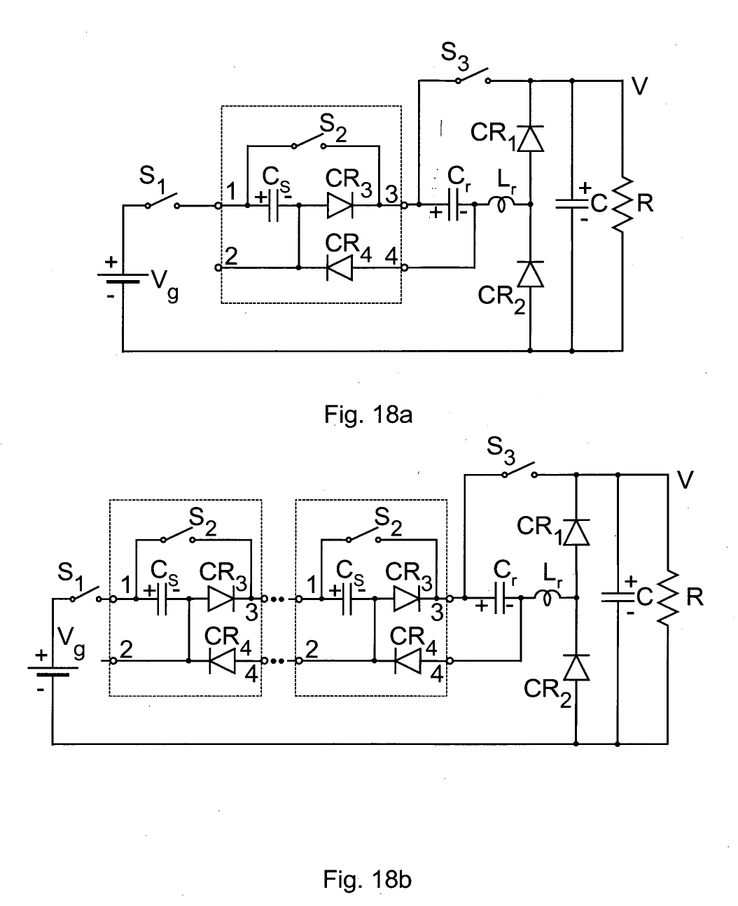

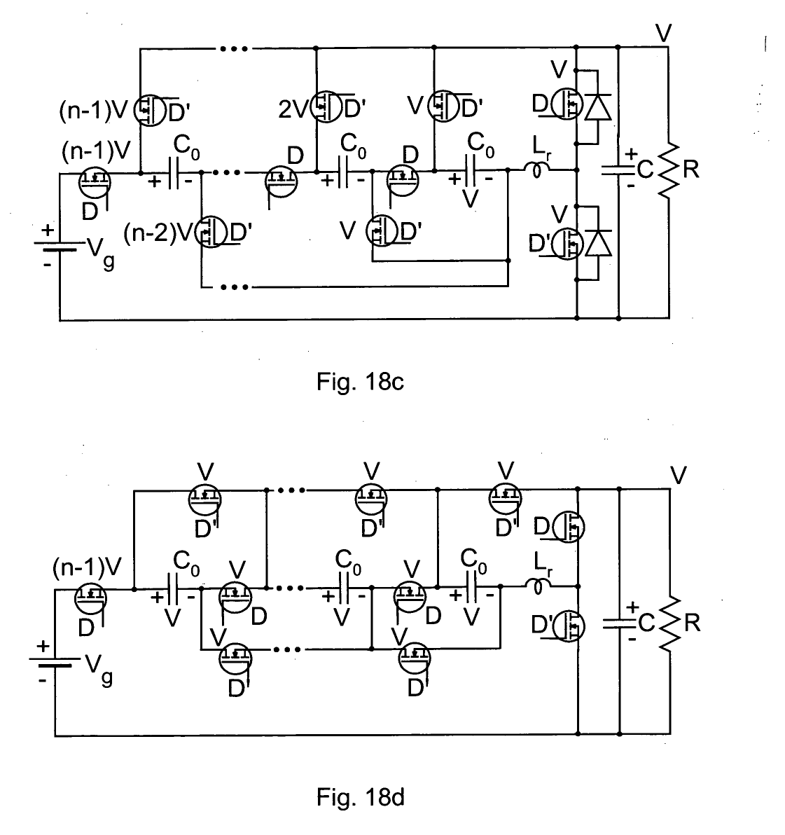

The minimum switch realization is shown in FIG. 18a in which the least number of controllable switches are used and two-terminal current rectifiers are used wherever possible. Note also the change of the component designations since this drawing is used to describe the converter topology in the claims and direct correspondence can be established with that in the claims. The generalized converter is shown in FIG. 18b. Note that the voltage stresses for all switches in the four-terminal blocks are equal and identical to the low voltage output voltage. For example, if output voltage is V, all devise will have voltage rating equal to 1V. When these switches are built with planar IC technology, the area apportioned to each silicon-switching device is proportional to square of the voltage rating of switches. Hence the silicon area needed for the switches can be substantially reduced. Alternatively, for the same silicon area, the devices could be built with much reduced conduction losses.

Implementation with All MOSFET Transistors

Shown in FIG. 18c is another embodiment in which all switches are implemented by N-channel MOSFET transistors. This is important for applications with low voltage outputs, such as 1V and 2V in which MOSFET transistors with ultra low ON resistance (1 mΩ or lower) are used to reduce the conduction losses and improve the efficiency. In the implementation in FIG. 18d, the switches have voltage blocking ratings ranging from V to 2V, 3V to (n−1)V where V is the output DC voltage. This is to be compared to the switches in buck converter in which all switches have the blocking requirement of the input DC voltage. Thus, for example, for 12V input voltage, devices with 20V or higher voltage rating are needed.

### Embodiment with Device Voltage Stresses Equal to Output DC Voltage

The implementation in FIG. 18b has all switches except one (the main input switch) having the voltage ratings equal to the output DC voltage. Clearly this is a huge advantage for implementation using Integrated Circuits. For example, for 12:1 step-down converter operating from 12V input voltage, the output DC voltage is 1V. Thus, voltage rating for all but one switch will be 1V. This embodiment of the invention lends itself to further advantages if all the switches are implemented in a single integrated circuit with built in drive circuits as well. As the ON-resistance of the devices is proportional to square of the rated voltage, the use of low voltage rated devices such as 1V or 2V would result in further reduction of the size and cost of the silicon needed as well as simultaneously improved efficiency.

### Other Embodiments

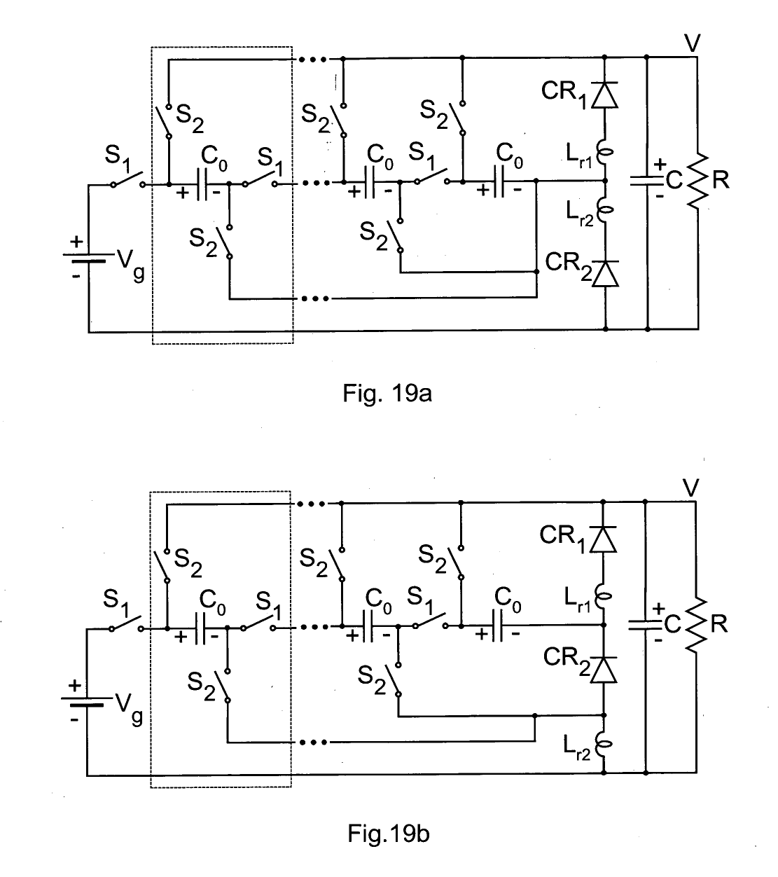

Yet another embodiment is shown in FIG. 19a in which two resonant inductors are used, with each resonant inductor being placed in a branch with the corresponding output diode rectifier. This therefore gives an additional flexibility to independently control the two resonant frequencies, since one resonant inductor resulted in limiting choice of defining two separate resonant frequencies as particular discrete integer ratios such as 2:1 3:1, etc. Finally, the embodiment in FIG. 19b further improves efficiency, since the current in the current rectifier CR₂ carries the resonant current of only one resonant capacitor (one directly connected to it on the cathode side) and not the sum of all resonant capacitors as the previous embodiments did.

Comparison of the Present Invention with the Prior-Art Buck Converter

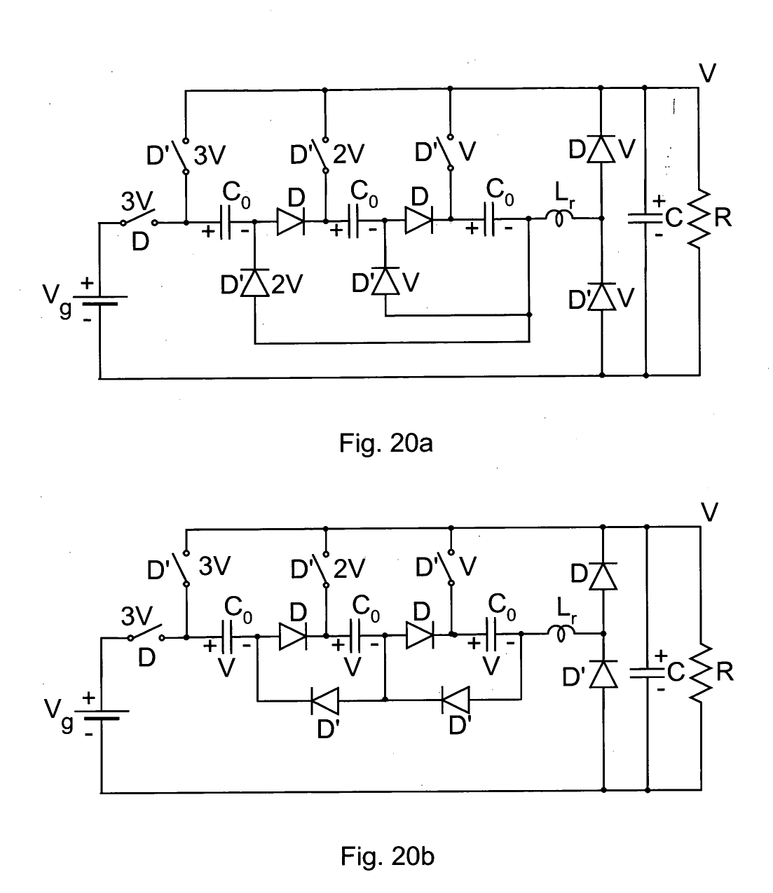

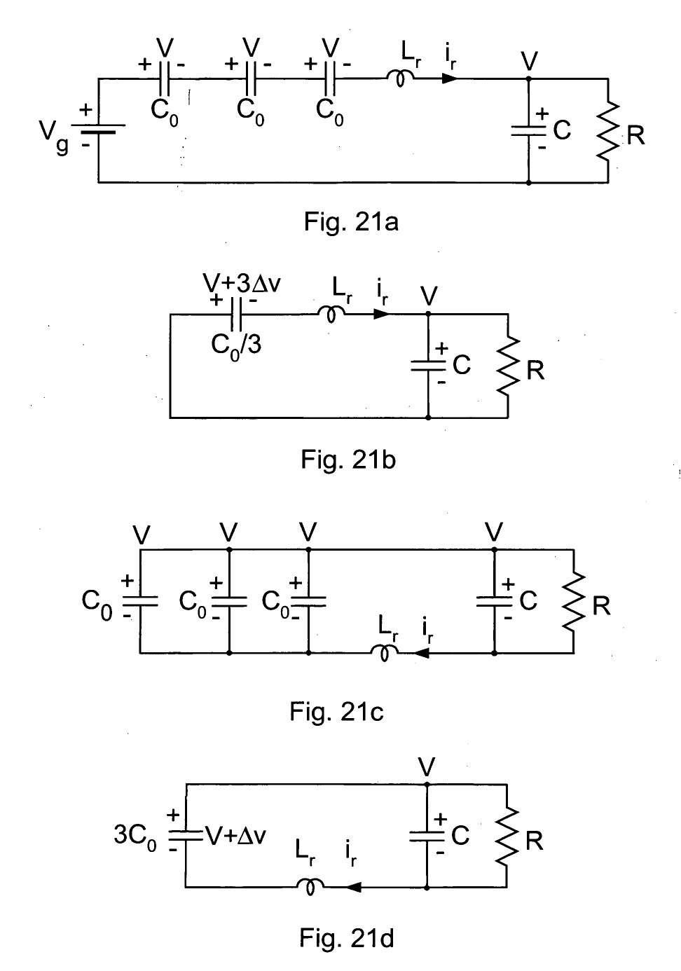

We now take a special case of the 4:1 step-down converter to compare it with the buck converter operating at D=0.25 and therefore resulting in the same 4:1 conversion ratio. Special case of 4:1 step-down converter is demonstrated with reference to FIG. 20a to FIG. 20b. The equivalent circuit models for 4:1 step-down converter are shown in FIGS. 21a-d.

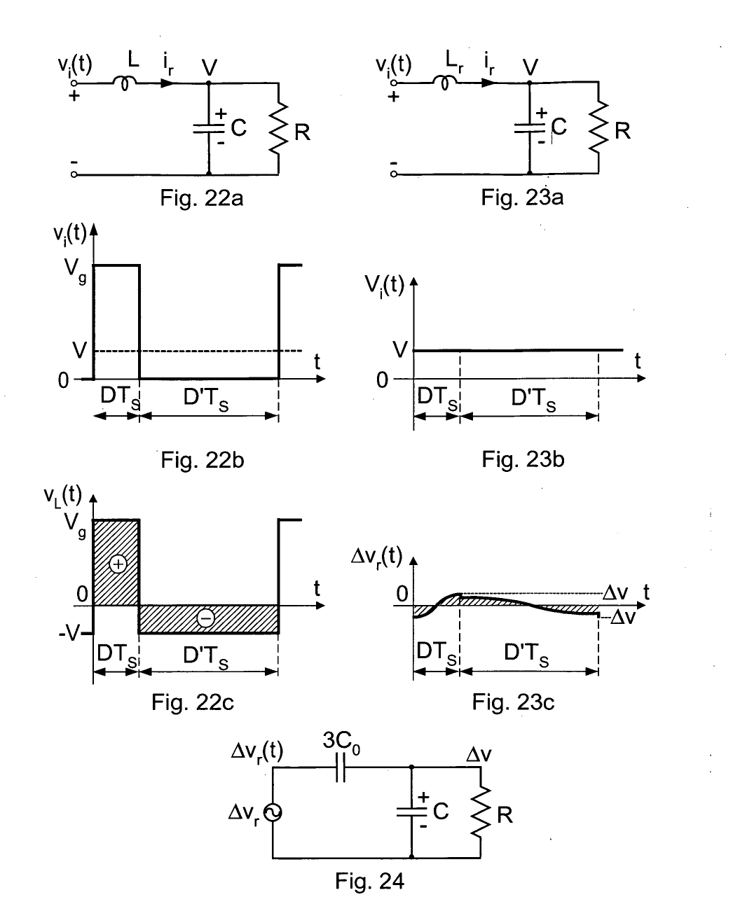

We now compare the filtering effectiveness of the two converters. The buck converter output filter of FIG. 22a has a square-wave input voltage (FIG. 22b) with a large AC square-wave voltage (FIG. 22c), which must be filtered out by output LC filter to provide the DC average of this waveform. The present invention, on the other hand, has an effective resonant filtering (FIG. 23a) whose input vᵢ has the same DC value V as the output voltage V (FIG. 23b) to which only a very small AC ripple voltage Δvᵣ is superimposed (FIG. 23c). As one converter has a large square wave voltage excitation, while the other has only AC ripple voltage, clearly AC flux requirements are much reduced in comparison to the buck converter by a factor of 10 to 40. In addition, inductor values needed for an effective filtering are much reduced, as the following comparison will demonstrate. For the buck converter, the relative ripple voltage can be calculated from the formula:

Δv/V=(¼)π²(1−D)(f_{c}/fₛ)² (54)

For the present invention, the output ripple voltage can be calculated from

Δv=(⅓)Δvᵣ₂Cᵣ₂/C (55)

where

Δvᵣ₂=½R_{N2}πI_{L} (56)

Equation (55) is derived from the equivalent circuit model in FIG. 24. We now compare the design of two converters for 12V to 4V, 6 A output with 1% relative ripple voltage requirement.

### Buck Converter Example

fₛ=500 kHz L=0.9 μH C=30 μF inductor AC ripple current 6 A (100% of DC)

### Present Invention Step-down 3:1 Converter (8 W Breadboard Demonstration)

fₛ=50 kHz Lᵣ=3 μH C=50 μF Δvᵣ=1.3V Δv=0.4V (0.1V measured)

The ripple currents measured on a 3:1 step-down prototype of a 24V to 8V, 1A converter is shown in FIG. 25. The top trace is the resonant inductor current shown for reference purposes. Second trace is the measured AC ripple voltage on the resonant capacitor of around 1V. Finally, the bottom trace is the output ripple voltage of 100 mV, so approximately 1% relative ripple voltage. Note the double frequency of the output ripple voltage. This came as a consequence of the rectification of the resonant inductor current. Thus we have included an empirical factor of ⅓ in the formula (55) to account for that.

### Electronic Selection of Several Discrete Conversion Ratios

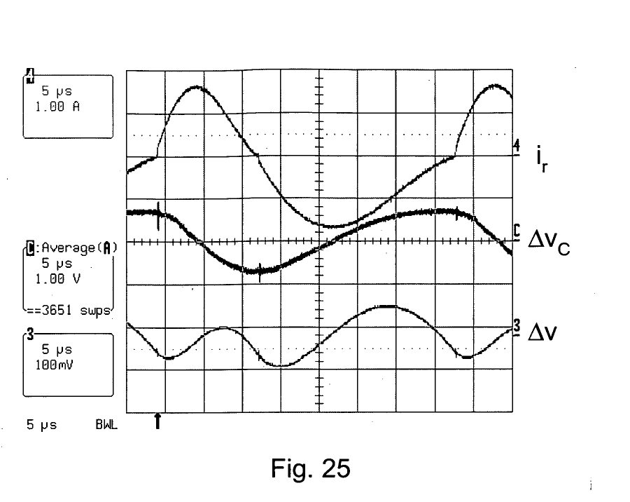

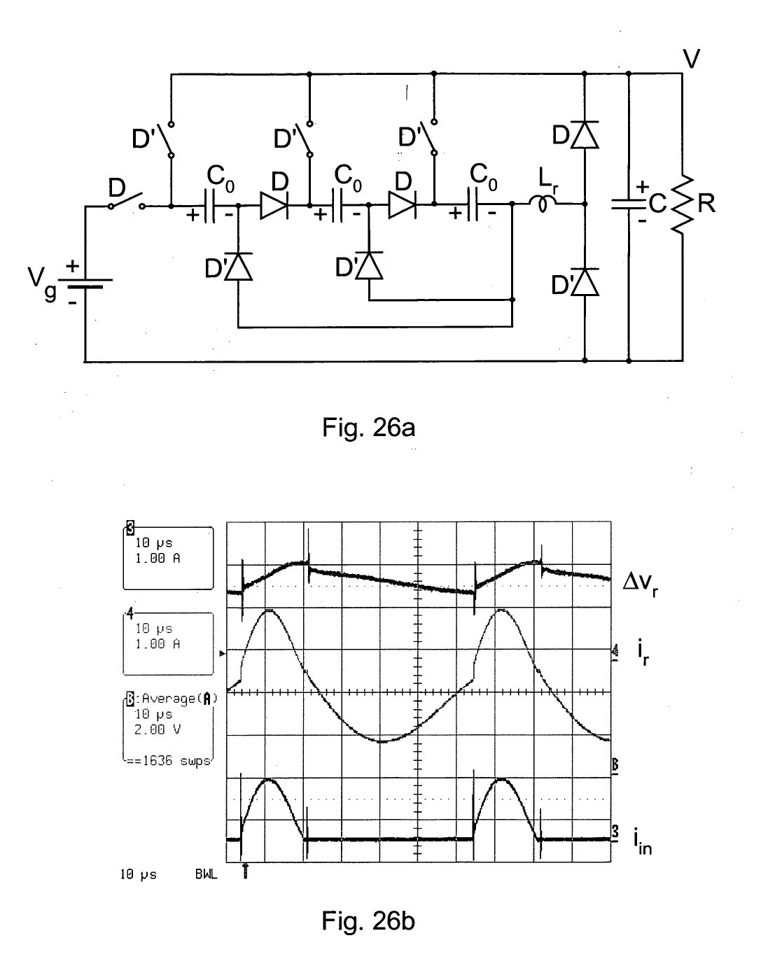

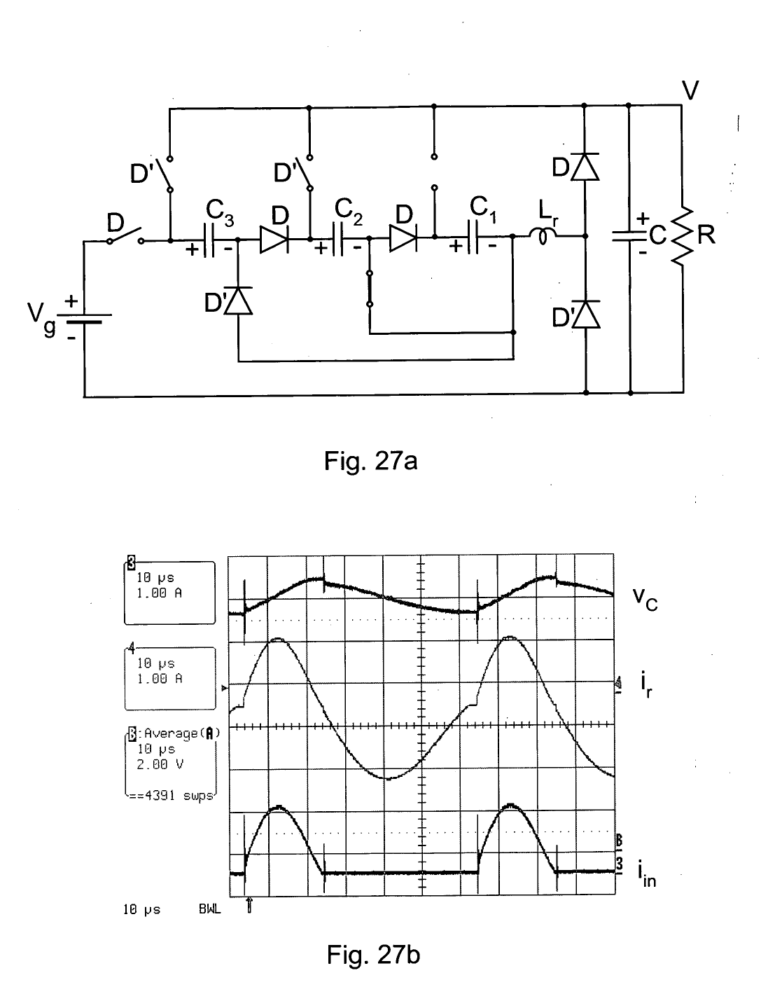

We now demonstrate how single 4:1 converter can be used to generate a number of fixed conversion ratios, such as 4:1, 3:1, and 2:1, by use of the appropriate drive controls. FIG. 26a shows a basic 4:1 converter used for the experimental measurements. It was adjusted to operate at 0.25 duty ratio to obtain the desired zero current crossovers as shown in FIG. 26b. Then the converter is modified for 3:1 step-down operation as in FIG. 27a by shorting permanently one diode switch and keeping one other switch open. The duty ratio is then changed to 0.33, which results in a short zero resonant inductor current during OFF-time period, which by a slight increase in switching frequency (of a few percents) results in the current waveforms of FIG. 27b.

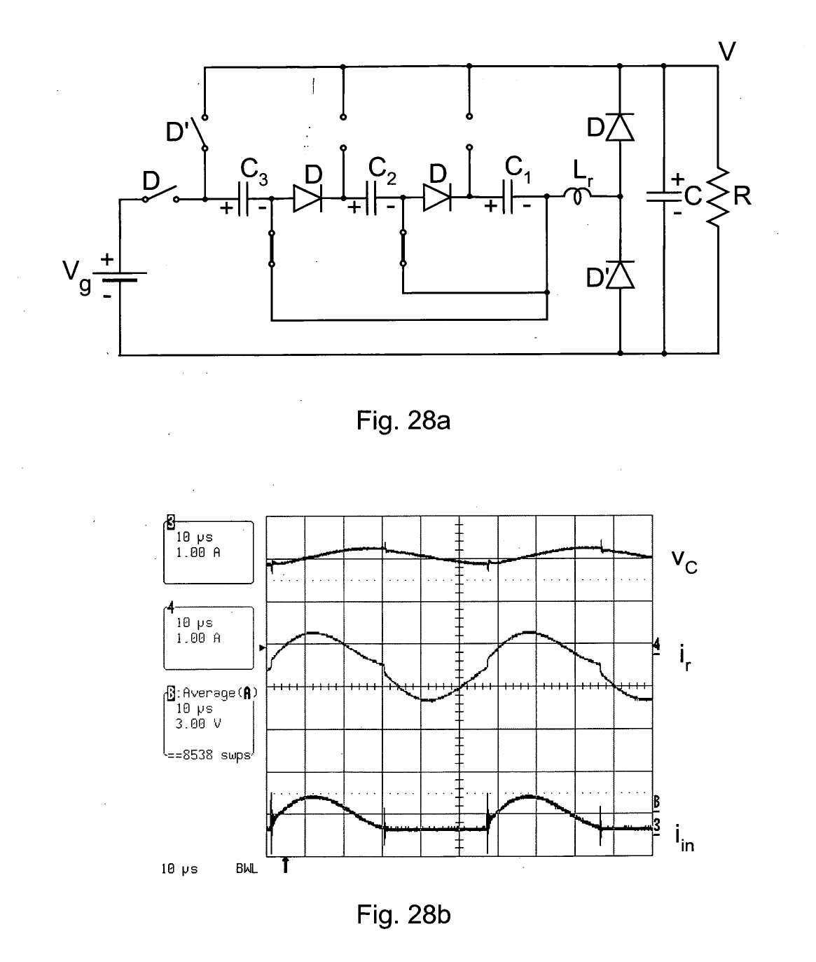

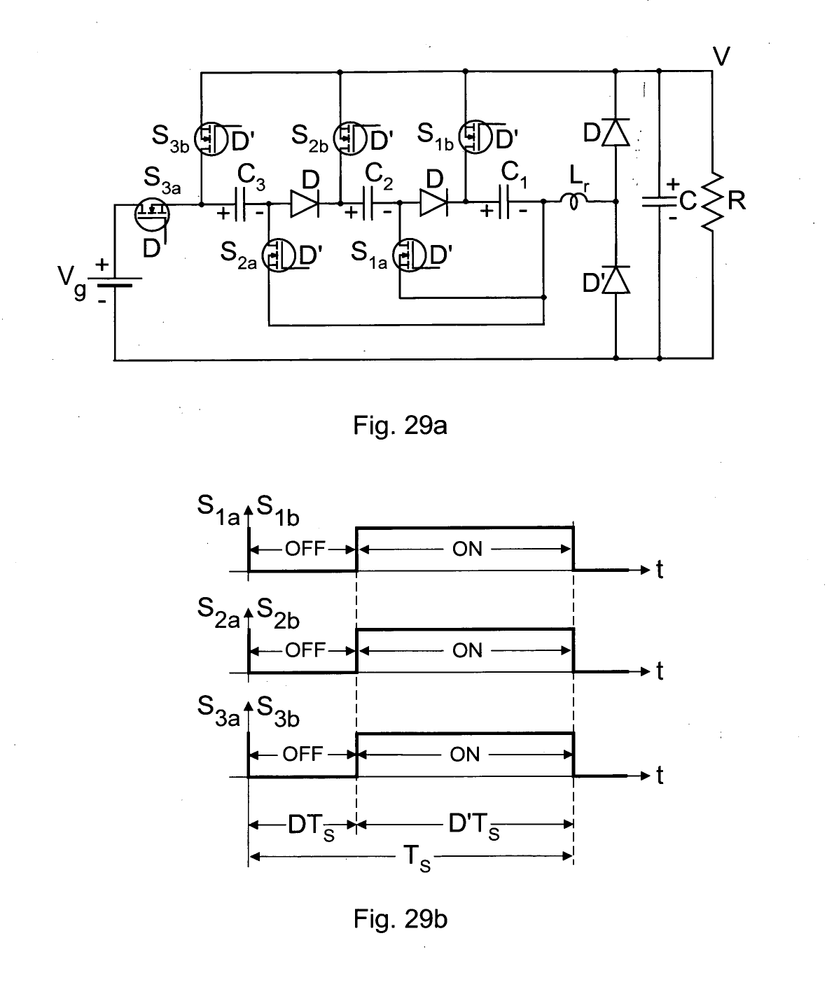

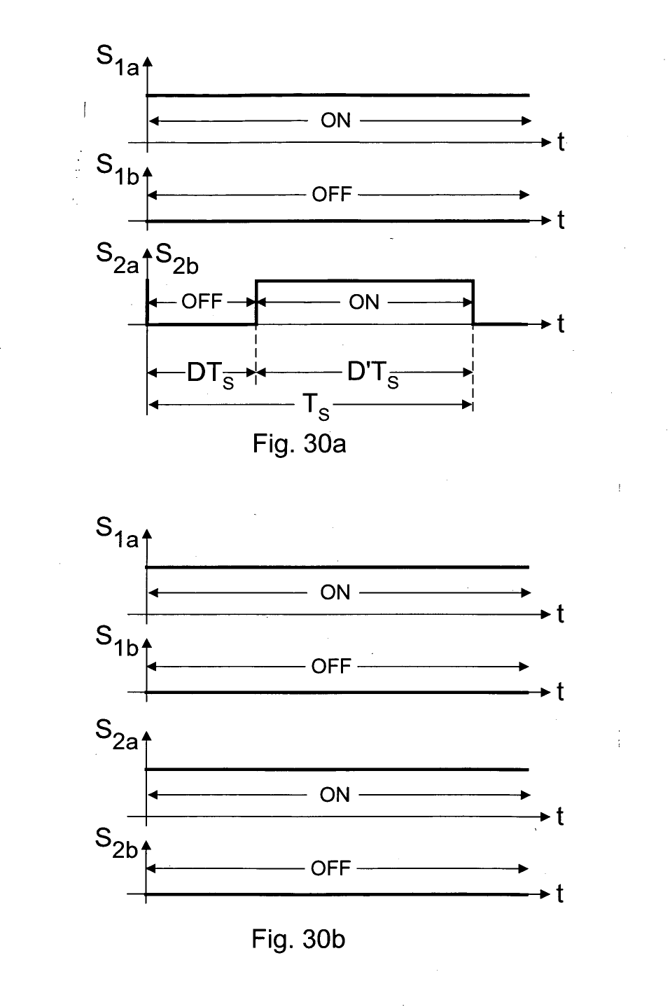

Next, the converter is modified for 2:1 step-down operation as shown in FIG. 28a. We now adjust the duty ratio to 0.25 and switching frequency to eliminate zero current coasting intervals to result in the waveforms shown in FIG. 28b. Finally, an all-electronic single converter is made which can change between the three fixed conversion ratios by simply choosing appropriate drives for the switching devices in the converter of FIG. 29a. For example, the drive illustrated in FIG. 29b will result in 4:1 conversion ratio. By applying the switch drives of FIG. 30a, the 3:1 step-down conversion is obtained. Note how the switch S₁ₐ is turned permanently ON, while switch S_{1b} is kept permanently OFF. Finally, the drives in FIG. 30b will result in 2:1 step-down conversion, when additional pair of switches, S₂ₐ and S_{2b} are controlled appropriately.

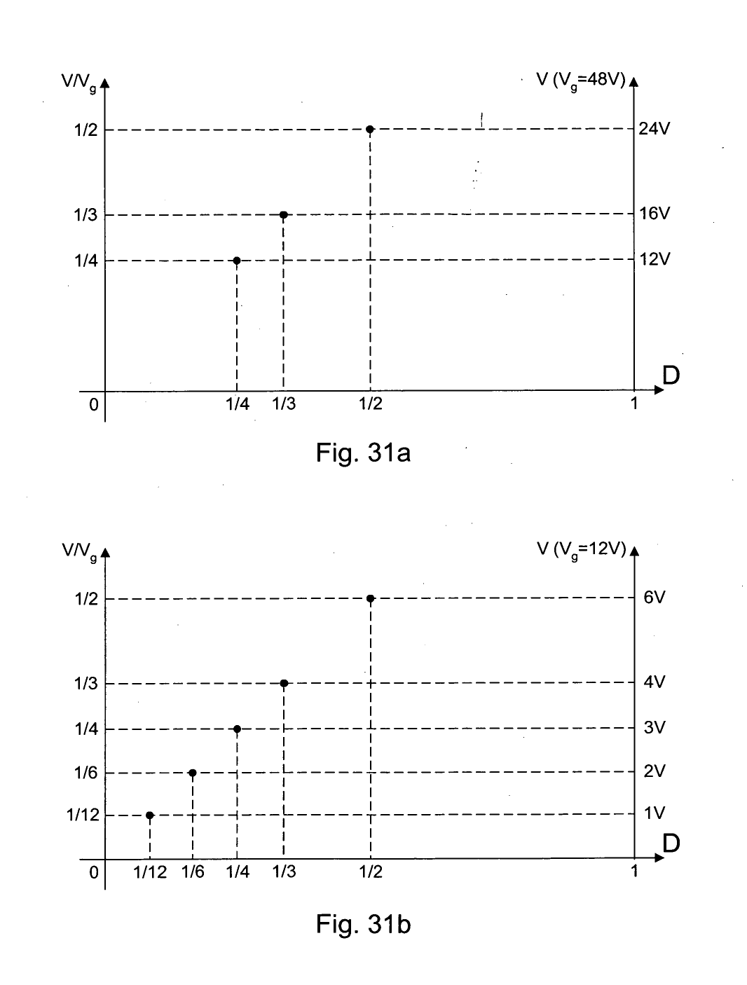

The three fixed conversion ratios available can now be summarized in FIG. 31a for a 4:1 step-down converter. Similarly, for a 12:1 step-down converter a lot more discrete choices are available especially for very low voltages. For example, for a 12V input, the following DC output voltages can be obtained:

1V, 1.2V, 1.33V, 1.5V, 1.71V, 2.0V, 2.4V, . . . , 6V (57)

### Continuous Control of the Output DC Voltage

At first it may appear that this converter is limited to only discrete conversion ratios and that the output DC voltages cannot be controlled in a continuous way as in conventional switching converters. This is, however, not the case, as all methods available for the control of switching converters can also be implemented for the converter of present invention. The two most important methods are:

a) Variable duty ratio D, constant switching frequency;

b) Constant duty ratio and variable switching frequency.

The first method of duty ratio control has not been available in the past for control of any type of the resonant converters, as they could only be controlled by varying the ratio of the switching frequency to the resonant frequency. Thus, we demonstrated for the first time the new method based on duty ratio control despite the converter having, in fact, two resonant circuits.

The other three control possibilities are the minor variations of the above two methods. They are:

1. Variable ON time and variable OFF time;

2. Constant ON time, variable OFF-time;

3. Variable ON-time, constant OFF-time.

### Duty Ratio Control

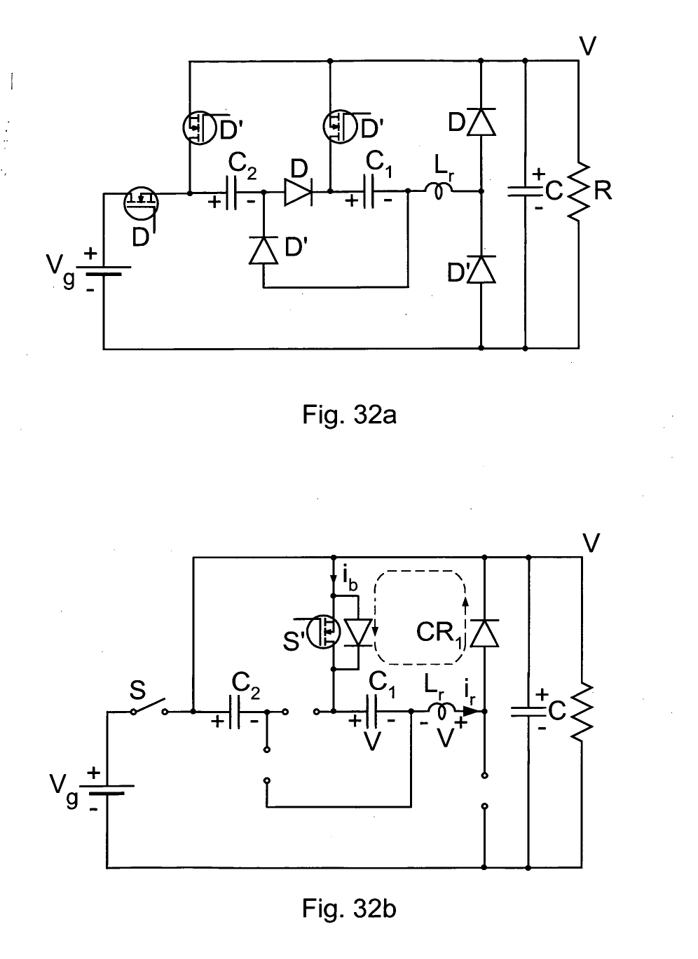

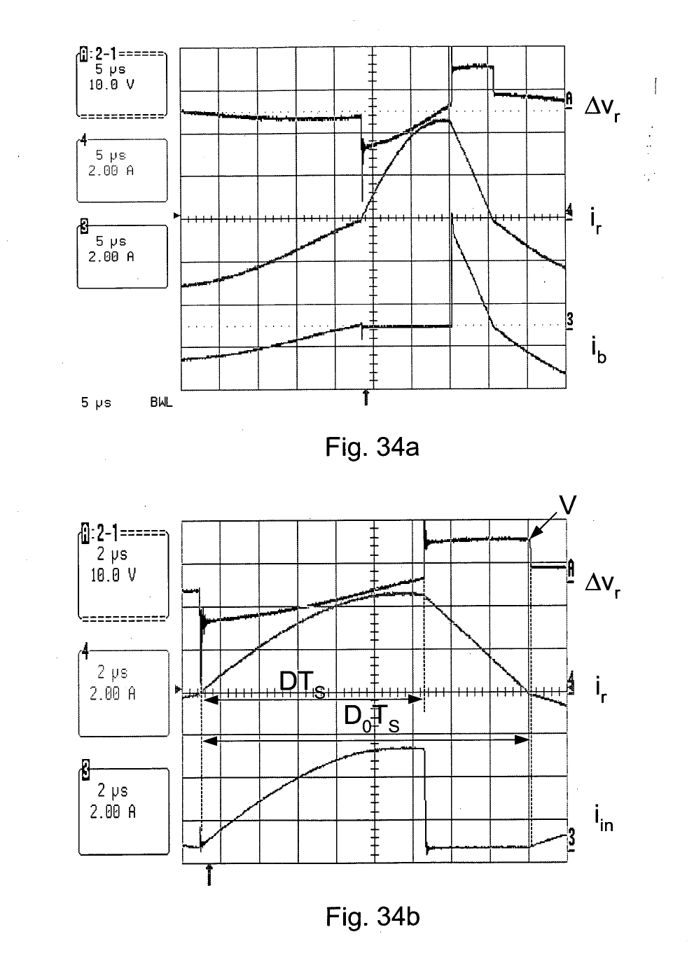

This method is illustrated on an example of a 3:1 step-down converter shown in FIG. 32a. The method is based on turning-OFF the main switch S before the resonant inductor current iₜ has reached zero current level. At first it would appear that such circuit condition is not permissible, as it would require that the resonant inductor current be interrupted with still a substantial energy stored on it and no current path to flow. This current interruption would result in increase of the voltage across some switches and ultimately their failure. Not so here as just the opposite is taking place. Note the direction of the resonant inductor current flow in the converter of FIG. 32b. The assumption is that the current rectifier CR₁ should turn-OFF in response to the turn-OFF of the main switch S just in the same way as the all other diode switches in series with it were turned OFF stopping, for example, the flow of current in capacitor C₂ in FIG. 32b.The diode rectifier CR₁, however, cannot turn-OFF as the resonant inductor current keeps this rectifier ON since it has found an alternate current path. This alternate current path is the body diode of the MOSFET transistor switch S′ through which the resonant inductor current does not normally flow. This is experimentally verified by measuring the current i_{b} of S switch as illustrated by the bottom (third) trace in the experimental waveforms shown in FIG. 34a. When S switch is turned-OFF, switch S′ is simultaneously turned-ON. However, the resonant inductor current does not flow through this switch in its usual active region direction but in opposite direction through its body diode as shown by the positive linearly decreasing current in bottom trace of FIG. 34a.

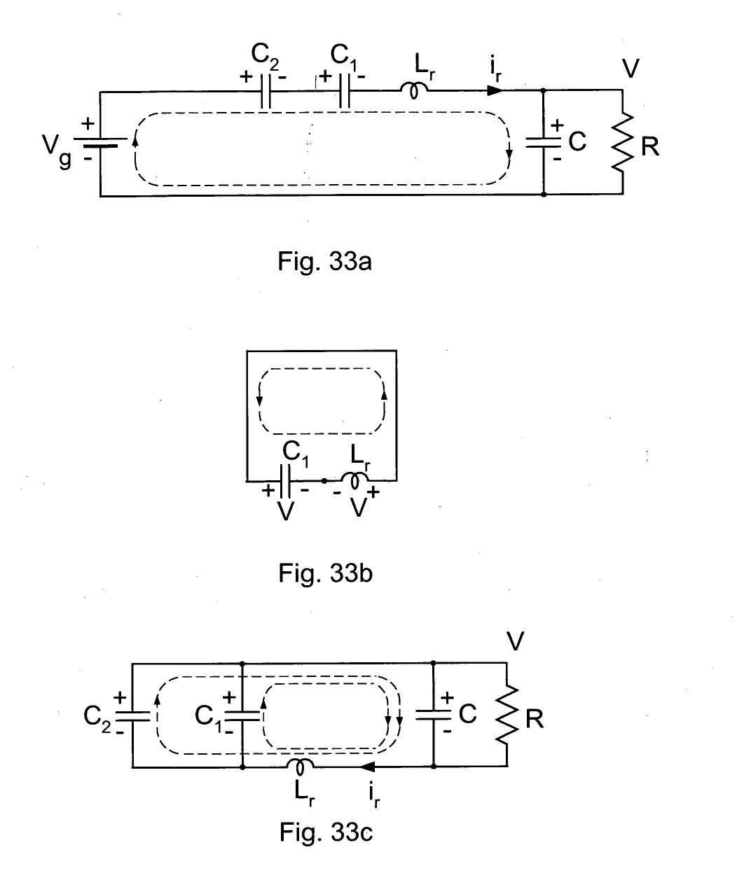

This results in the creation of an additional linear circuit network shown in FIG. 33b. The original converter of FIG. 5a and all subsequent embodiments presented so far, consisted of switching only between the two linear networks: one for charging resonant capacitors in series (FIG. 33a), and the other of their discharging in parallel (FIG. 33c). The linear circuit of FIG. 33b shows that the energy stored in the resonant inductor is now being linearly discharging into the capacitor C₁, which holds a constant voltage V across it, equal to output DC voltage. Thus, resonant inductor releases its energy to resonant capacitor thereby charging it. Only when this resonant current is reduced to zero, will the current rectifier CR₁ turn-OFF and simultaneously CR₂ turn-ON to result in discharge interval.

Note that this linear discharge of the resonant inductor current with the slope of V/L, does not appear in either input current nor in the output load current, as it is simply circulating internally as seen in FIG. 32b. The experimental waveform of the input current is show as a third (bottom) trace in FIG. 34b confirming that the input current does not contain this linear resonant discharge part.

The reduction of the duty ratio must result in smaller output voltage V, since this linear discharge part is taking a proportionally much bigger byte of the input current than of the output current thus modulating input to output DC current conversion ratio and ultimately the DC voltage conversion ratio. Thus, the substantial reduction of the DC input current results while having almost no effect on DC load current. This effectively translates into a larger and larger DC voltage step-down with further reduction of the duty ratio. When the duty ratio is reduced to zero, the DC voltage on output is also reduced to zero. Thus, the smooth soft start from initial zero output voltage to final regulated DC output voltage could be accomplished. Like-wise the smooth shut down can be implemented as well.

Note also that this voltage reduction method is effective for any DC load current, which is not the case for voltage control using the variable switching frequency and constant duty ratio. For high efficiency, all the diodes should be replaced by the MOSFETs.

### Three Resonant Circuits

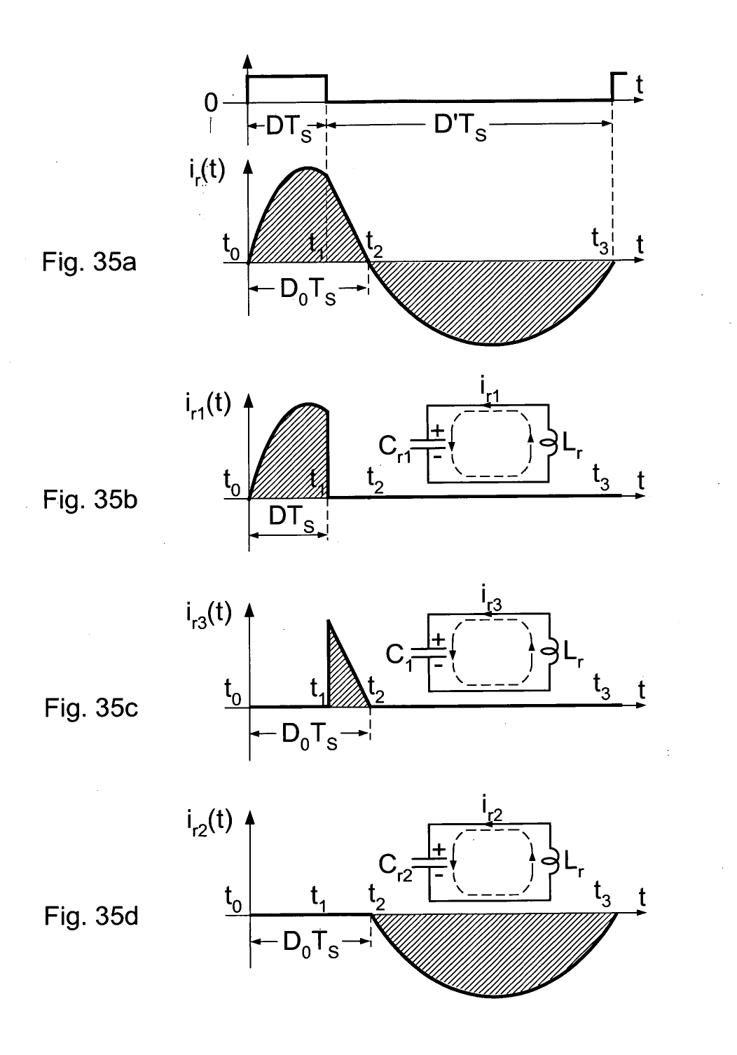

The duty ratio control thus effectively splits, the previous first resonant charging interval into two resonant charging intervals, thus resulting in effectively three resonant circuits, each applicable in respective resonant interval as illustrated by the resonant inductor current iₜ of FIG. 35a and the respective resonant currents for three intervals: (t₀-t₁) interval (FIG. 35b), (t₁-t₂) interval (FIG. 35c), and (t₂-t₃) interval (FIG. 35d) with corresponding equivalent circuit shown along with the resonant current waveforms.

The previous two resonant current waveforms retained the same reference designation given before, that is, iᵣ₁ and iᵣ₂ as they are governed by the same analytical solution as given before, except now limited to the new intervals. The new linear resonant discharge current of the resonant inductor is now given a designation iᵣ₃. As seen in FIG. 35c, this resonant circuit continuous to release its stored energy, but instead of to all capacitors in series, it releases its stored energy to capacitor C₁ only, while all other resonant capacitors do not participate in it and have zero current during this resonant charge interval (t₁-t₂).

The resonant current and voltage equations for this interval (t₁-t₂) are given by the same classical parallel resonant circuit equations, that is:

Lᵣdiᵣ₃/dt=−vᵣ₃ (58)

C₁dv₃/dt=−iᵣ₃ (59)

except the solution in this interval takes no longer sinusoidal and co-sinusoidal form but instead is given by:

iᵣ₃(t)=I_{P}V/Lᵣ(t−t₁) (60)

vᵣ₃(t)=V (61)

Thus, (60) describes the linear discharge of the resonant inductor into capacitor C₁, while (61) confirms that the capacitor voltage during this time is constant and equal to DC output voltage V. This can be easily confirmed by observing the experimental waveform of the voltage on resonant inductor during this interval in the first trace of FIG. 34a (see the square bump in that waveform, whose magnitude is V).

Note a completely new phenomenon not observed in any heretofore known resonant circuits, either linear or switched-mode. The resonant circuit operates either as a linear resonant circuit with sinusoidal solution for current and voltage and then changes to solution for voltage as constant V and for current as a linear current flow.

The time when resonant current is reduced to zero is varying according to the conduction time of the body diode of switch S′ which is apparently changing in response to duty ratio D. Thus, MOSFET switch S′ in the converter of FIG. 32b must be turned-OFF precisely when resonant inductor reaches zero current. Such zero crossing time can be determined by sensing the resonant inductor current and turning this switch OFF at that instant in time. Therefore timing of turn-OFF of this switch will be different and controlled separately from the timing of all other S₂ switches in the converter of FIG. 6a.

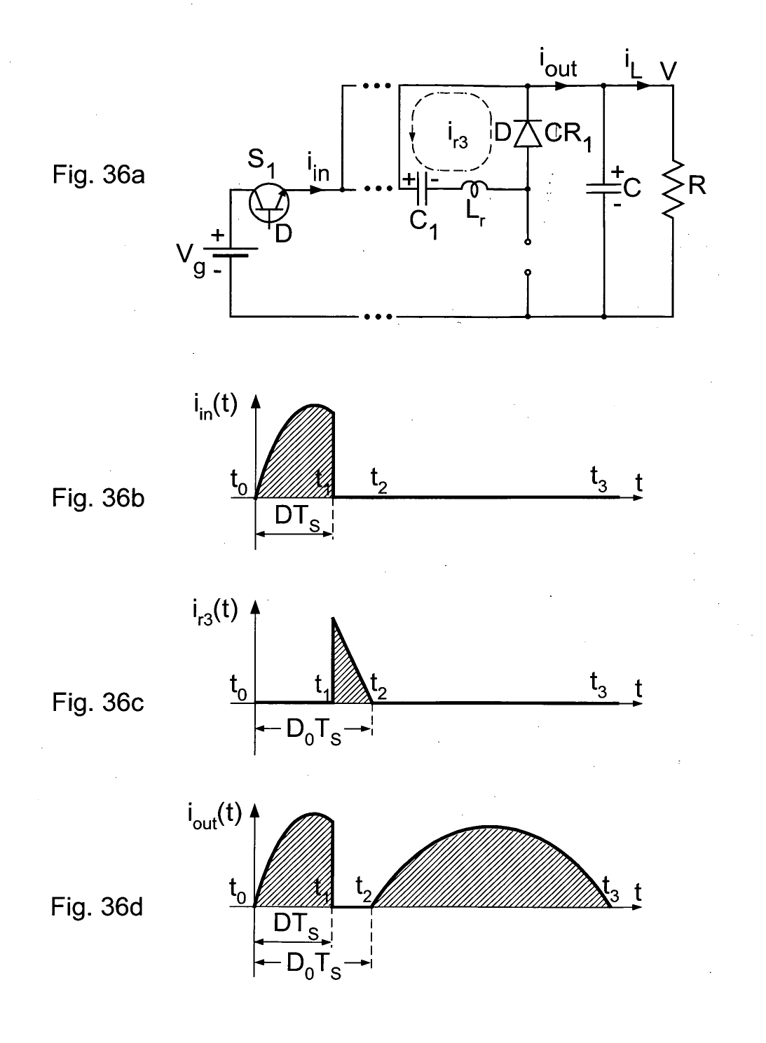

Shown in FIG. 36a is generalized converter with n-stages. FIG. 36b show that the linear resonant inductor discharge current of FIG. 36c is chopped off and eliminated from the input current thereby reducing substantially the DC input current. On the other hand, the same current is also eliminated from the output load current as seen in FIG. 36d where it has a much-reduced effect. Note that this linear resonant inductor discharge current is shown as circulating current iᵣ₃ charging the resonant capacitor C₁ in FIG. 36a.

### Duty Ratio Modulation of the Current Conversion Ratio

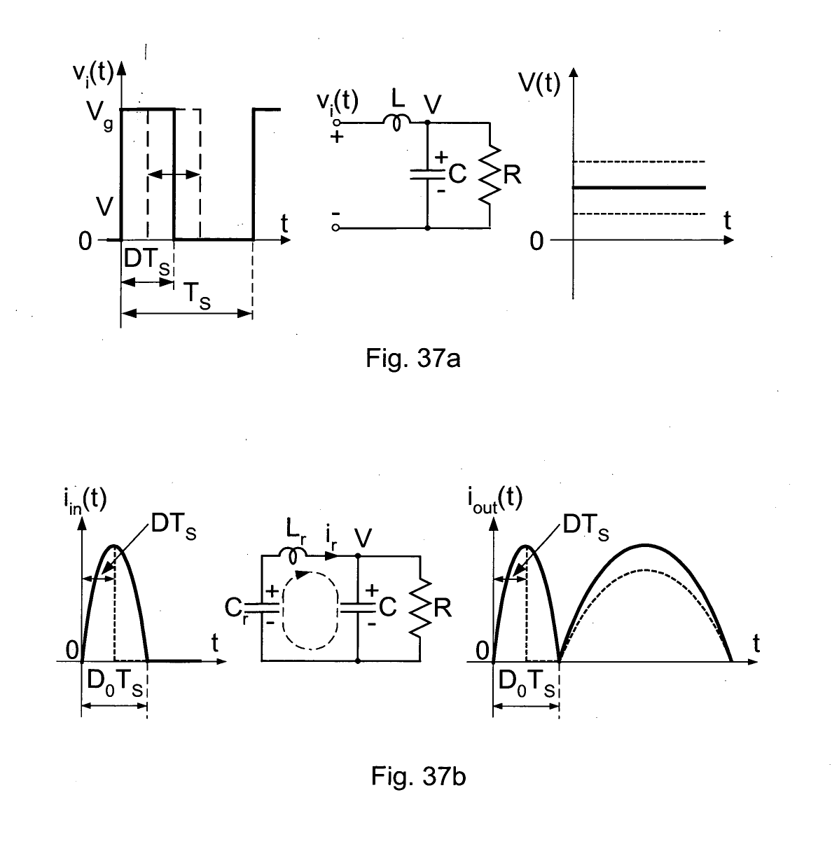

This method of duty ratio control is based on the Pulse Width Modulation (PWM) of the DC current conversion ratio (FIG. 37a) as opposed to PWM modulation of the DC voltage conversion ratio as in conventional buck converter (FIG. 37b). In the present invention, just as we derived the discrete DC voltage conversion ratio (29) from discrete DC current conversion ratio (28), we do the same now to obtain:

V/V_{g}=1/n for D≧1/n (62)

where (62) is the previously described constant conversion ratio and

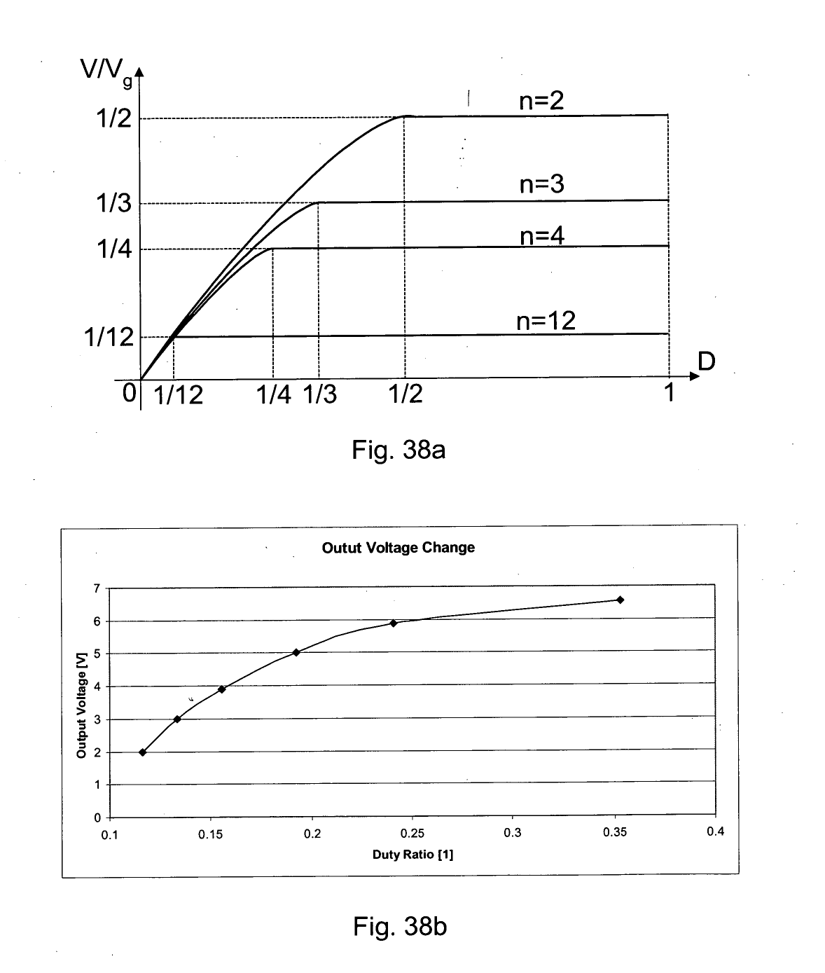

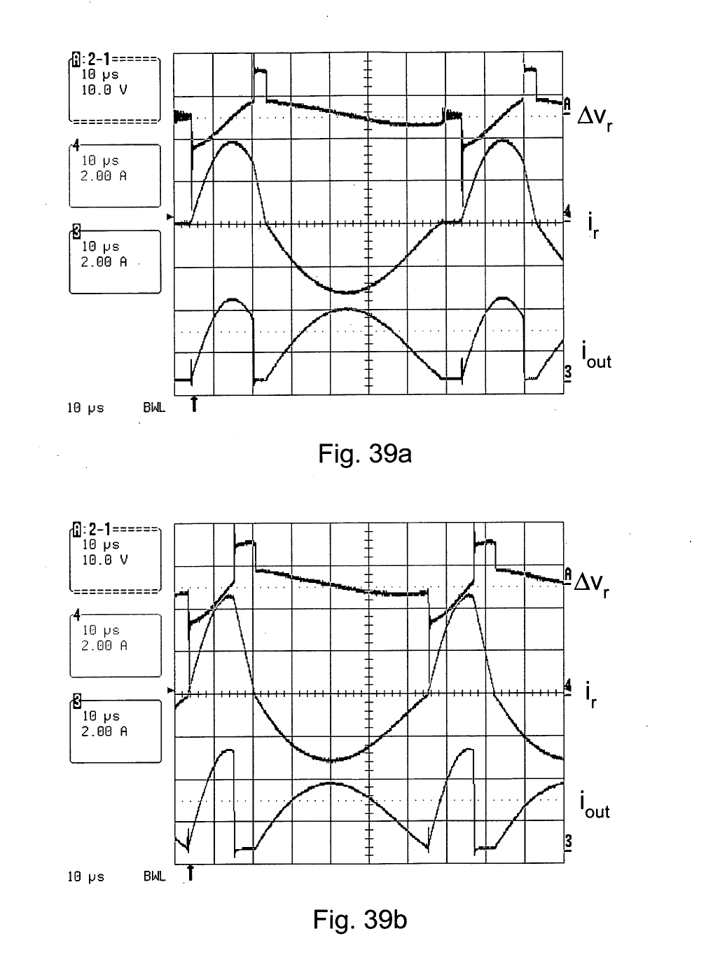

V/V_{g}=f₁(D)1/n for D≦1/n (63)

where f₁(D) is a continuous DC voltage reduction added as a consequence of the just described PWM modulation of the DC conversion ratio with function f₁ (D) depending on controlling duty ratio D and other circuit parameters and load current. The important result is that the DC conversion ratio can be controlled fully down to zero duty ratio, which corresponds to zero output DC voltage. This is illustrated by a family of theoretical DC voltage conversion ratio curves in FIG. 38a, in which fixed conversion ratio 1/n is a running parameter. The experimental DC voltage conversion characteristic obtained for the 3:1 step-down converter (n=3) for 24V to 8V output introduced earlier in calculation of the ripple voltages is shown in FIG. 38b. FIG. 39a and FIG. 39b illustrate salient waveforms recorded on the above 3:1 prototype.

### Switching Frequency Control

The DC output voltage could also be controlled by increasing the switching frequency fₛ relative to the reference resonant frequency fᵣ defined as

1/fᵣ=0.5(1/fᵣ₁+1/fᵣ₂) (64)

In this case, the duty ratio D is kept constant at the value given by:

D=1/n (65)

while the output DC voltage is controlled by changing the dimensionless control parameter f_{c} given by:

f_{c}=fₛ/fᵣ (66)

The output DC voltage can then be described in respective two regions:

V/V_{g}=1/n for f_{c}=1 (67)

V/V_{g}=f₂(f_{c})1/n for f_{c}≧1 (68)

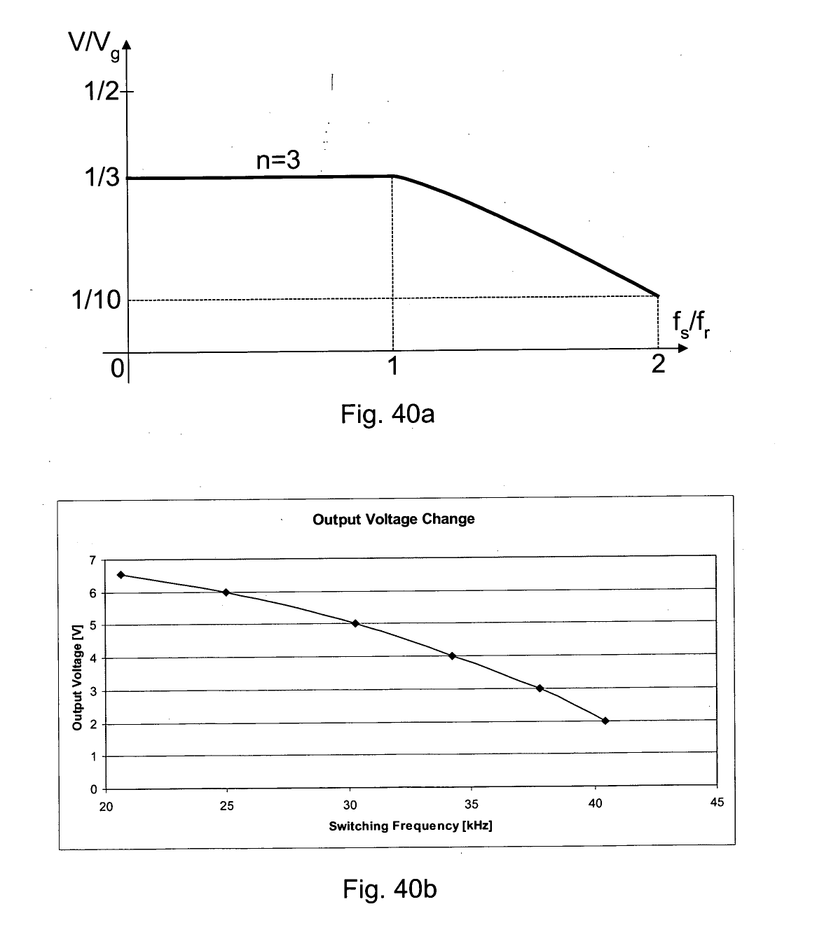

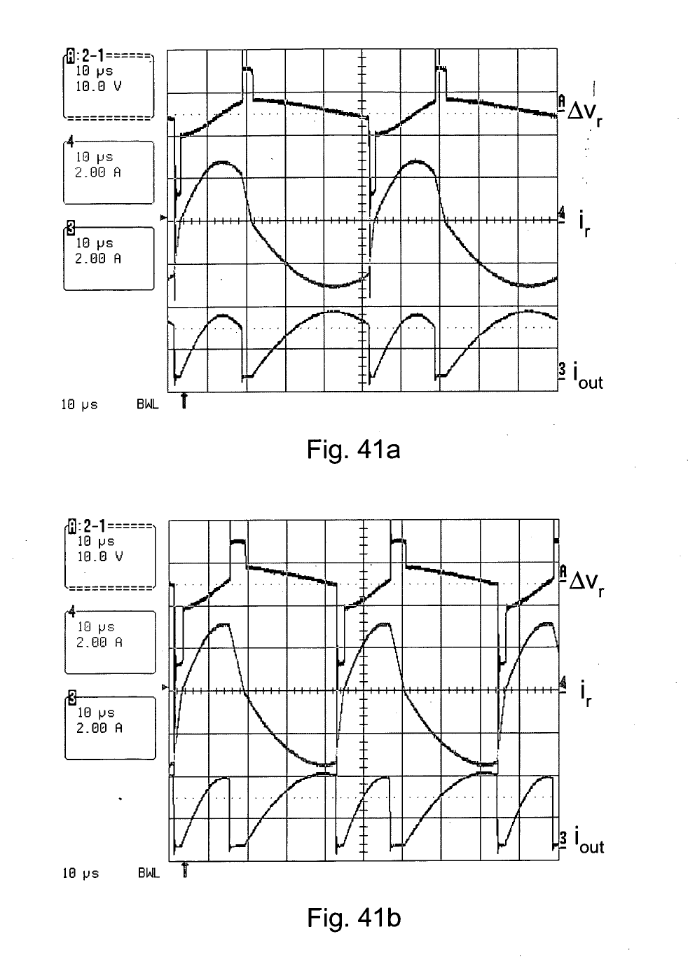

The theoretical DC voltage conversion for constant D=⅓ (n=3) with changing control parameter f_{c} is illustrated in diagram of FIG. 40a. The same 3:1 step-down prototype is then used to record the DC voltage gain characteristic with increasing switching frequency from 20 kHz to 40 kHz, thus changing f_{c} from 1 to 2 as seen in FIG. 40b. The DC voltage gain was observed changing from approximately ⅓ of input DC voltage (V_{g}=24V) to 1/10 of the input DC voltage for an effective 10:1 overall step-down conversion for 2:1 increase in switching frequency. FIG. 41a and FIG. 41b show the salient waveforms observed on experimental prototype.

### Experimental Verification of Low Ripple, Transient Response and Efficiency

The experimental prototype of the converter embodiment in FIG. 18a was built to verify the following key performance features:

a) fast transient response.
b) all switches turning ON and turning OFF at zero current thus eliminating switching losses
c) high efficiency.

A 3:1 step-down version was built operating at 24 W from 12V source and delivering 6 A into 4V load using all n-channel MOSFET transistors for its 7 switches. The following components were used:

MOSFET transistors: International Rectifer IRFH5250 1.15mΩ, 30VΩ device (7 devices):

C₁=C₂=C₀=110 μF, Cᵣ₁=55 μF, Cᵣ₂=220 μF, fᵣ₁=80 kHz, fᵣ₂=80 kHz, fᵣ=53 kHz (69)

C=500 μF, Lᵣ=70 nH , R_{N2}=18 mΩ (70)

The converter was operated at constant duty ratio D=⅓ and constant switching frequency fₛ=53 kHz.

### Output Ripple Voltage

From the formulas given, the resonant ripple voltage was calculated as 0.34V from (56) and output ripple voltage was calculated as 50 mV from (55) and measured as 70 mV, which is less than 2% relative output ripple voltage. This has verified one of the key features of the converter: the requirement for typical low voltage ripple on the output on the order of 1% to 2% of the output DC voltage was achieved but operating at a very low switching frequency of 50 kHz. In addition, an extremely small inductor value of 70nH was used to accomplish this. Thus, the inductor implementation did not use any magnetic cores, as it was realized as simple one turn air-core inductor. Clearly, there are no core losses and copper losses are negligible.

The equivalent buck converter under the same conditions, 24V to 4V, 6 A and same 50 mV output ripple voltage was calculated to require:

fₛ=500 kHz L=0.9 μH C=30 μF inductor AC ripple current 6 A (100% of DC).

The present invention therefore resulted in same ripple voltage but at switching frequency of 50 kHz, which is 10 times lower than the buck converter. Despite such lower switching frequency, the inductance value needed for the converter of present invention is 70nH or 13 times smaller than 900 nH inductance needed for the buck converter. Clearly 900 nH inductance must be built on a magnetic core in order to obtain such increased inductance value needed. This would not only introduce additional copper losses but core losses of magnetic cores due to high switching frequency needed and high AC flux utilized. Finally, the cost savings and size saving by use of single turn copper trace for resonant inductor implementation in present invention are considerable in comparison with large magnetic core of the buck converter.

Note also that one could not use much higher output capacitance in order to reduce the inductance needed in buck converter since the current ripple on output inductor and corresponding AC flux would be extremely big, as in the above design it is already at 6 A peak to peak or 100% of its DC value.

### Transient Response

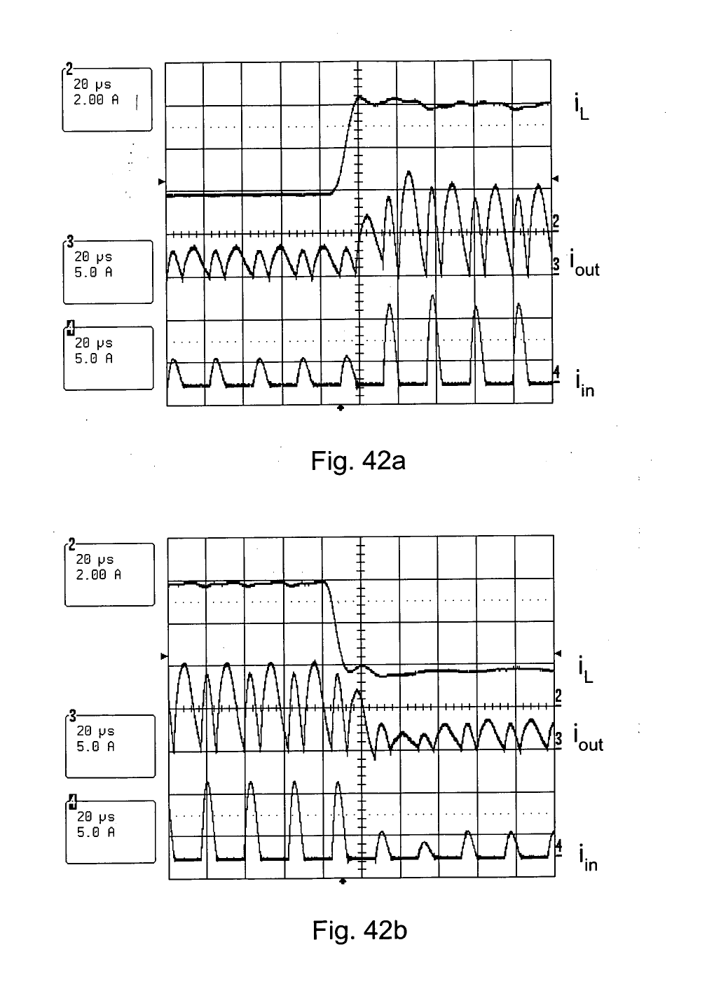

To test the transient response, the load current is changed from 2A to 6 A as shown by top trace in FIG. 42a and the instantaneous waveforms of the output current lₒᵤₜ recorded as second trace in FIG. 42a. Finally, the bottom trace in FIG. 42b represents the corresponding current iᵢₙ drawn from the input voltage source. Note how the pulses of the input current are immediately responding to the output load current pulses iₒᵤₜ on a single cycle basis, which in turn are likewise responding to sudden change of DC load current. Note also how the current pulses are returning to zero current level each cycle confirming that this converter, unlike buck converter does not need a large number of cycles to settle down to a new steady state at new DC current level, but instead it is accomplishing this in one or two cycles. Clearly operating at higher switching frequency, for example, 500 kHz will make even aster response to sudden large current demand.

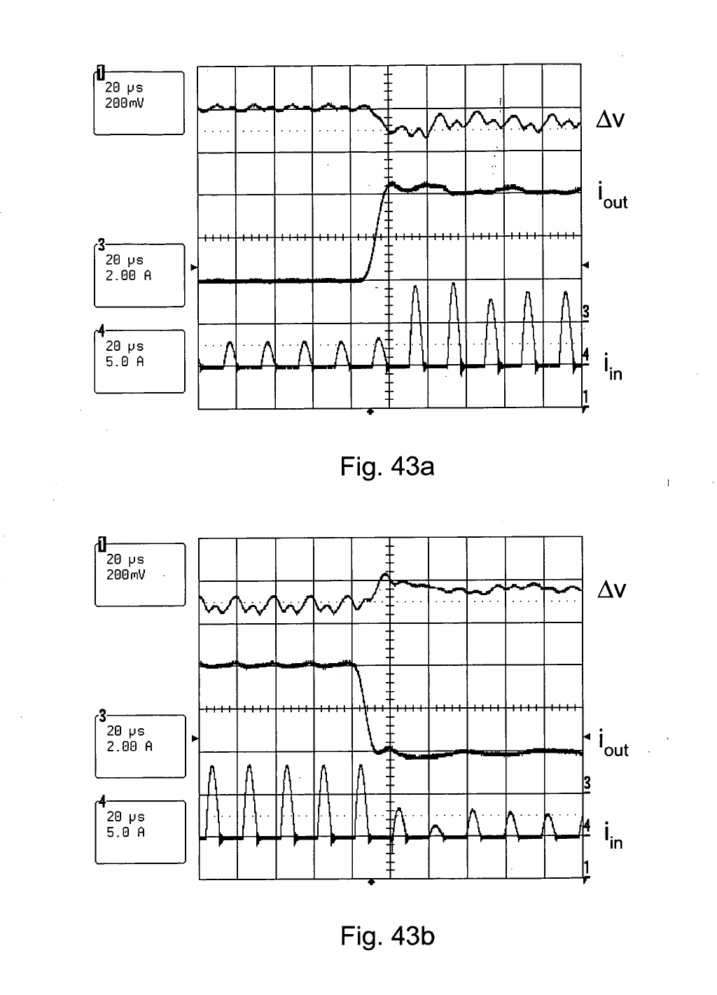

FIG. 42a demonstrates the same performance for the opposite step-load current change from 6 A to 2 A) for a 100% to 33% load current change leading to the same observations. Of practical importance is the transient voltage overshoots and undershoots during such transient change. FIG. 43a and FIG. 43b demonstrate that the output voltage transient is approximately 100 mV or approximately 2% of the DC output of 4V.

### Efficiency Measurements

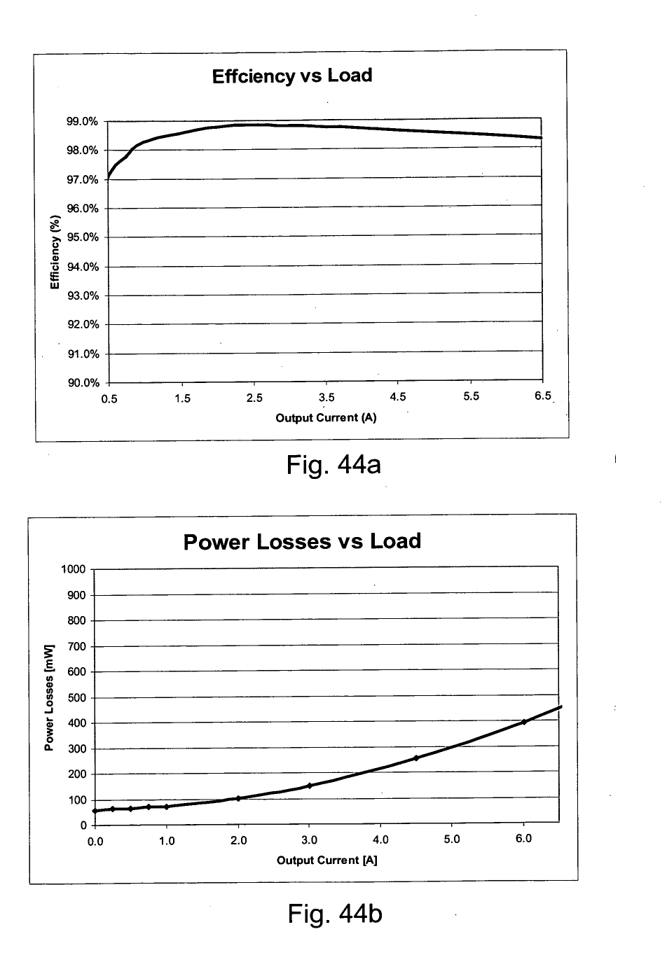

Efficiency of the power stage was measured over the load current range of 0.5A to 6.5A and shown in FIG. 44a while the corresponding loss measurements are recorded and shown in FIG. 44b. Note extremely low losses, such as 300 mW when operating at 5 A or 20 W load power.; Note also an almost constant efficiency curve changing from almost 99% at 2.5 A to 98.2% at 6.5 A. The gate drive and housekeeping losses were not included, but due to operation at 50 kHz they are also relatively small and practically negligible.

### CONCLUSION

The step-down converter of present invention has key advantages over the present buck convert in several key areas and provides:
1. High efficiency.
2. Small size of the inductor at moderate o low switching frequencies including one turn air-core inductor implementation.
3. Inherently fast transient response on a single switching cycle basis.
4. Smaller overall converter size and large power capability.
5. Elimination of all switching losses.
6. Control of the DC voltage conversion ratio by use of either duty ratio or variable switching frequency control.

What is claimed is:

1. A non-isolated switching DC-to-DC converter for providing power from a DC voltage source connected between an input terminal and a common terminal to a DC load connected between an output terminal and said common terminal, said converter comprising:
a four-terminal switching block comprising three switches, a first switch (S₂), a second switch (CR₃), a third switch (CR₄), and a switching capacitor (C_{S}), having said first switch connected between a first terminal (1) and a second terminal (2), said second switch connected with one end to a third terminal (3), said fourth switch connected with one end to a fourth terminal (4) and another end connected to another end of said second switch, and said switching capacitor connected between said first terminal and said another end of said third switch;
a controllable input switch (S₁) with one end connected to said input terminal and another end connected to said first terminal of said four-terminal switching block;
a controllable complementary switch (S₃) with one end connected to said output terminal and said second terminal of said four-terminal switching block, and another end connected to said third terminal of said four-terminal switching block;
a resonant capacitor (Cᵣ) connected between said third terminal and said fourth terminal of said four-terminal switching block;
a resonant inductor (Lᵣ) with one end connected to said fourth terminal of said four-terminal switching block;
a first current rectifier (CR₁) switch with a cathode end connected to said output terminal and an anode end connected to another end of said resonant inductor;
a second current rectifier (CR₂) switch with a cathode end connected to said another end of said resonant inductor and an anode end connected to said common terminal;
an output capacitor (C) with one end connected to said output terminal and another end connected to said common terminal;
switching means for keeping said input switch ON and said first switch and said complementary switch OFF during ON-time interval DT_{S}, and keeping said input switch OFF and said first switch and said complementary switch ON during OFF-time interval D′T_{S}, where D is a duty ratio and D′ is a complementary duty ratio within one complete and controlled switch operating period T_{S};
wherein said second switch and said third switch are semiconductor current rectifiers;
wherein said resonant capacitor and said switching capacitor have equal capacitance values significantly smaller than capacitance of said output capacitor;
wherein said resonant inductor and said resonant capacitor in series with said switching capacitor form a first resonant circuit during said ON-time interval and define a first resonant frequency and corresponding first resonant period;
wherein said switching capacitor in parallel with said resonant capacitor and in series with said resonant inductor form a second resonant circuit during said OFF-time interval and define a second resonant frequency and corresponding second resonant period;
wherein said ON-time interval is set to be equal to half of said first resonant period;
wherein during said ON-time interval only a positive half-sinusoidal resonant current of said first resonant circuit flows from said DC source into said DC load;
wherein said OFF-time interval is set to be equal to half of said second resonant period;
wherein during said OFF-time interval only a positive half-sinusoidal resonant current of said second resonant circuit flows into said DC load;
wherein said ON-time interval and said OFF-time interval define a reference resonant frequency;
whereby said switching operating period T_{S} is three times longer than said ON-time interval corresponding to said duty ratio D of one third;
whereby a DC load current is sum of both said half-sinusoidal resonant current of said first resonant circuit and said half-sinusoidal resonant current of said second resonant circuit, while a DC source current is equal to said half-sinusoidal resonant current of said first resonant circuit;
whereby all switches are turned ON and turned OFF at zero current level with no switching losses;
whereby said converter in steady-state has a three-to-one DC voltage step-down;
whereby continuous reduction of said duty ratio D below one third results in continuous reduction of output DC voltage below said three-to-one DC voltage step-down;
whereby voltage stresses on said first current rectifier switch, said second current rectifier switch, said complementary switch and said third switch are equal to said output voltage, and
whereby DC voltages across said switching capacitor and said resonant capacitor are equal to said output DC voltage,
whereby there is no circulating current between said switching capacitor and said resonant capacitor during said OFF-time interval, and
whereby said output voltage has the same polarity as said DC voltage source.

2. A converter as defined in claim 1,
wherein a second four-terminal switching block identical to said four-terminal switching block is inserted between said input switch and said four-terminal switching block so that said another end of said input switch is connected to a first terminal of said second four-terminal switching block, a second, third, and fourth terminal of said second four-terminal switching block are connected respectively to said second, first, and fourth terminal of said four-terminal switching block;
wherein said switching means controls switches of said second four-terminal switching block in the same way as it controls respective switches of said four-terminal switching block;
wherein said resonant inductor and said resonant capacitor in series with switching capacitors of said two four-terminal switching blocks form a first resonant circuit during said ON-time interval and define a first resonant frequency and corresponding first resonant period;
whereby said converter in steady-state operates with said duty ratio of one-fourth and has a four-to-one DC voltage step-down, and
whereby continuous reduction of said duty ratio D below one-fourth results in continuous reduction of output DC voltage below said four-to-one DC voltage step-down.

3. A converter as defined in claim 2,
wherein N additional four-terminal switching blocks identical to said four-terminal switching block are inserted in the same way between said input switch and said second four-terminal switching block;
wherein said switching means controls switches of said N additional four-terminal switching block in the same way as it controls respective switches of said four-terminal switching block;
wherein said resonant inductor and said resonant capacitor in series with switching capacitors of said N additional four-terminal switching blocks form a first resonant circuit during said ON-time interval and define a first resonant frequency and corresponding first resonant period;
whereby said converter in steady-state operates at said duty ratio D equal to 1/(N+4) and has a (N+4) to 1 DC voltage step-down, and
whereby continuous reduction of said duty ratio D below 1/(N+4) results in continuous reduction of said output DC voltage below said (N+4) to 1 DC voltage step-down.

4. A converter as defined in claim 1,
wherein said input switch, said first switch, and said complementary switch are semiconductor bipolar transistors;

5. A converter as defined in claim 4,
wherein said input switch, said first switch, said second switch, said third switch, and said complementary switch are MOSFET transistors.

6. A converter as defined in claim 5,
wherein said first current rectifier switch, and said second current rectifier switch are two MOSFET transistors operated as synchronous rectifiers to reduce conduction losses, and
whereby said switching means operate said two MOSFET transistors so that they are turned ON only during conduction time of their respective body diodes.

7. A converter as defined in claim 1,
wherein said resonant inductor is disconnected and a first resonant inductor and a second resonant inductor are inserted, having one end of said first resonant inductor connected to said another end of said resonant capacitor and another end connected to said anode end of said first current rectifier switch, one end of said second resonant inductor connected to said forth terminal of said four-terminal switching block and another end connected to said cathode end of said second current rectifier switch, and
whereby said first resonant inductor and said second resonant inductor independently define said first resonant period and said second resonant period.

8. A converter as defined in claim 7,
wherein one end of said resonant capacitor is disconnected from said fourth terminal of said four-terminal switching block, said another end of said second resonant inductor is disconnected from said cathode end of said second current rectifier switch and connected to said common terminal, and said cathode end of said second current rectifier switch is connected to said one end of said first resonant inductor.

9. A non-isolated switching DC-to-DC converter for providing power from a DC voltage source connected between an input terminal and a common terminal to a DC load connected between an output terminal and said common terminal, said converter comprising:
a four-terminal switching block comprising three switches, a first switch (S₂), a second switch (CR₃) a third switch (CR₄) and a switching capacitor (C_{S}), having said first switch connected between a first terminal (1) and a third terminal (3), said second switch connected between a second terminal (2) and said third terminal, said third switch connected between said second terminal and a fourth terminal (4), and said switching capacitor connected between said first terminal and said second terminal;
an input switch (S₁) with one end connected to said input terminal and another end connected to said first terminal of said four-terminal switching block;
a complementary switch (S₃) with one end connected to said output terminal and another end connected to said third terminal of said four-terminal switching block;
a resonant capacitor (Cᵣ) connected between said third terminal and said fourth terminal of said four-terminal switching block;
a resonant inductor (Lᵣ) with one end connected to said fourth terminal of said four-terminal switching block;
a first current rectifier switch (CR₁) with a cathode end connected to said output terminal and an anode end connected to another end of said resonant inductor;
a second current rectifier switch (CR₂) with a cathode end connected to said another end of said resonant inductor and an anode end connected to said common terminal;
an output capacitor (C) with one end connected to said output terminal and another end connected to said common terminal;
switching means for keeping said input switch ON and said first switch and said complementary switch OFF during ON-time interval DT_{S}, and keeping said input switch OFF and said first switch and said complementary switch ON during OFF-time interval D′T_{S}, where D is a duty ratio and D′ is a complementary duty ratio within one complete and controlled switch operating cycle T_{S};
wherein said second switch and said third switch are semiconductor current rectifiers;
wherein said resonant capacitor and said switching capacitor have equal capacitance values significantly smaller than capacitance of said output capacitor;
wherein said resonant inductor and said resonant capacitor in series with said switching capacitor form a first resonant circuit during said ON-time interval and define a first resonant frequency and corresponding first resonant period;
wherein said switching capacitor in parallel with said resonant capacitor and in series with said resonant inductor form a second resonant circuit during said OFF-time interval and define a second resonant frequency and corresponding second resonant period two times longer than said first resonant period;
wherein said ON-time interval is set to be equal to half of said first resonant period;
wherein during said ON-time interval only a positive half-sinusoidal resonant current of said first resonant circuit flows from said DC source into said DC load;
wherein said OFF-time interval is set to be equal to half of said second resonant period;
wherein during said OFF-time interval only a positive half-sinusoidal resonant current of said second resonant circuit flows into said DC load;
wherein said ON-time interval and said OFF-time interval define a reference resonant frequency;
whereby said switching operating period T_{S} is three times longer than said ON-time interval corresponding to said duty ratio D of one third;
whereby a DC load current is sum of both said half-sinusoidal resonant current of said first resonant circuit and said half-sinusoidal resonant current of said second resonant circuit, while a DC source current is equal to said half-sinusoidal resonant current of said first resonant circuit;
whereby all switches are turned ON and turned OFF at zero current level with no switching losses;
whereby said converter in steady-state has a three-to-one DC voltage step-down;
whereby continuous reduction of said duty ratio D by said switching means reduces said ON-time interval of said input switch below half of said first resonant period providing continuous control of output DC voltage to said DC load below said three-to-one DC voltage step-down;
whereby voltage stresses on said first current rectifier switch, said second current rectifier switch, said complementary switch and said third switch are equal to said output voltage, and
whereby DC voltages across said switching capacitor and said resonant capacitor are equal to said output DC voltage;
whereby there is no circulating current between said switching capacitor and said resonant capacitor during said OFF-time interval, and
whereby said output voltage has the same polarity as said DC voltage source.

10. A converter as defined in claim 9,
wherein a second four-terminal switching block identical to said four-terminal switching block is inserted between said input switch and said four-terminal switching block so that said another end of said input switch is connected to a first terminal of said second four-terminal switching block, a second, third, and fourth terminal of said second four-terminal switching block are connected respectively to said second, first, and fourth terminal of said four-terminal switching block;
wherein said switching means controls switches of said second four-terminal switching block in the same way as it controls respective switches of said four-terminal switching block;
wherein said resonant inductor and said resonant capacitor in series with switching capacitors of said two four-terminal switching blocks form a first resonant circuit during said ON-time interval and define a first resonant frequency and corresponding first resonant period;
whereby said converter in steady-state operates with said duty ratio of one-fourth and has a four-to-one DC voltage step-down, and
whereby continuous reduction of said duty ratio D below one-fourth results in continuous reduction of output DC voltage below said four-to-one DC voltage step-down.

11. A converter as defined in claim 10,
wherein N additional four-terminal switching blocks identical to said four-terminal switching block are inserted in the same way between said input switch and said second four-terminal switching block;
wherein said switching means controls switches of said N additional four-terminal switching block in the same way as it controls respective switches of said four-terminal switching block;
wherein said resonant inductor and said resonant capacitor in series with switching capacitors of said N additional four-terminal switching blocks form a first resonant circuit during said ON-time interval and define a first resonant frequency and corresponding first resonant period;
whereby said converter in steady-state operates at said duty ratio D equal to 1/(N+4) and has a (N+4) to 1 DC voltage step-down, and
whereby continuous reduction of said duty ratio D below 1/(N+4) results in continuous reduction of said output DC voltage below said (N+4) to 1 DC voltage step-down.

12. A converter as defined in claim 9,
wherein said input switch, said first switch, and said complementary switch are semiconductor bipolar transistors;
wherein said second switch and said third switch are semiconductor current rectifiers.

13. A converter as defined in claim 12,
wherein said input switch, said first switch, said second switch, said third switch, and said complementary switch are MOSFET transistors.

14. A converter as defined in claim 13,
wherein said first current rectifier switch, and said second current rectifier switch are two MOSFET transistors operated as synchronous rectifiers to reduce conduction losses, and
whereby said switching means operate said two MOSFET transistors so that they are turned ON only during conduction time of their respective body diodes.

15. A converter as defined in claim 9,
wherein said resonant inductor is disconnected and a first resonant inductor and a second resonant inductor are inserted, having one end of said first resonant inductor connected to said another end of said resonant capacitor and another end connected to said anode end of said first current rectifier switch, one end of said second resonant inductor connected to said forth terminal of said four-terminal switching block and another end connected to said cathode end of said second current rectifier switch, and
whereby said first resonant inductor and said second resonant inductor independently define said first resonant period and said second resonant period.

16. A converter as defined in claim 15,
wherein one end of said resonant capacitor is disconnected from said fourth terminal of said four-terminal switching block, said another end of said second resonant inductor is disconnected from said cathode end of said second current rectifier switch and connected to said common terminal, and said cathode end of said second current rectifier switch is connected to said one end of said first resonant inductor.

17. A converter as defined in claim 1,
wherein said duty ratio D is constant and equal to ⅓, and
whereby continuous increase of said switching frequency above said reference resonant frequency continually reduces said DC output voltage below said three-to-one DC voltage step-down.

18. A converter as defined in claim 9,
wherein said duty ratio D is constant and equal to ⅓, and
whereby continuous increase of said switching frequency above said reference resonant frequency continually reduces said DC output voltage below said three-to-one DC voltage step-down.

19. A switching method for DC-to-DC voltage conversion between a DC voltage source and a DC load,
whereby during ON-time interval resonant capacitors are connected in series with said DC voltage source and said DC load and charged through resonant inductor in series,
whereby during OFF-time interval said resonant capacitors are discharge in parallel through said resonant inductor to said DC load, and
whereby discrete and continuous DC voltage step-down is provided.
